(19) United States
(12) Patent Application Publication
(10) Pub. No.: US 2013/0159218 A1
(43) Pub. Date: Jun. 20, 2013

(54) INFORMATION PROCESSING APPARATUS AND METHOD

(71) Applicants: Shiho KIJIMA, Kanagawa (JP); Masayuki Ueda, Kanagawa (JP)

(72) Inventors: Shiho KIJIMA, Kanagawa (JP); Masayuki Ueda, Kanagawa (JP)

(73) Assignee: Ricoh Company, Ltd., Tokyo (JP)

(21) Appl. No.: 13/714,848

(22) Filed: Dec. 14, 2012

(30) Foreign Application Priority Data
Dec. 20, 2011 (JP) 2011-278977

(51) Int. Cl. G06Q 30/02

(52) U.S. Cl. CPC G06Q 30/0283
USPC 705/400

(57) ABSTRACT

An information processing apparatus outputs a manufacturing cost and a CO₂ emission amount for each of manufacturing processes which is capable of manufacturing an identical product. A processing CO₂ emission amount computation part computes, for each manufacturing process, a processing CO₂ emission amount exhausted in each of processing operations based on power consumption and a CO₂ emission amount per unit amount of an electric power. A total cost computation part computes a total cost including the process cost and a processing CO₂ emission amount required for a whole manufacturing process based on the process cost and the processing CO₂ emission amount of each of the processing operations.

### BACKGROUND OF THE INVENTION

1. Field of the Invention

The present invention relates to an information processing apparatus and method.

2. Description of the Related Art

In recent years, with increase in demand for environment-oriented products or energy-saving products, importance has been attached to products on the market as to how the products are manufactured in consideration of environment and energy saving. Information regarding power consumption of products of major manufacturers are open to public by a predetermined organization (for example, Energy Conservation Japan: ECCJ). Because consumers tend to purchase an electric appliance having low power consumption, which contributes to reduction of CO₂, such information is one of materials to make a determination when selecting a product to purchase.

Sometimes, for environmental consciousness, it is important to know how a product was manufactured in consideration of an environmental problem in that manufacturing process, such as, for example, how a product was manufactured while reducing CO₂ emission, how many recycled materials are used in a product, etc. Thus, recently, it has become important for a manufacturer to not only manufacture a product efficiently at a low cost but also to manufacture a product while suppressing CO₂ emission.

Here, in a manufacturing process of a product, there are many points associated with suppression of CO₂ emission. It is one of the important points to suppress a power consumption used in a manufacturing process of a product. Generally, in a product manufacturing facility, an extremely large electric power is used because products are manufactured using various machinery and equipments which use a large electric power to operate.

Specifically, in manufacturing a product such as, for example, a copy machine, the product is manufactured through various processes, such as procurement of materials, production of parts from the materials, assembly of the parts, etc. Among those processes, the parts manufacturing process especially requires a large electric power, which occupies a large weight in a total electric power used for manufacturing the product, because the product is manufactured in the parts manufacturing process using many machinery and equipments which require a large electric power. That is, how much CO₂ emission can be reduced in the parts manufacturing process gives a large influence to a reduction of CO₂ emission in the manufacturing process of the product.

As a technology regarding reduction of CO₂ emission, Patent Document 1 (Japanese Laid-Open Patent Application No. 2010-214667) discloses a power consumption calculating device which can calculate a power consumption of equipments. Using such a technology, for example, a power consumption of equipments including machineries, eventually CO₂ emission, can be calculated.

Here, in the above-mentioned manufacturing process, it was explained that a product is manufactured by a manufacturing process including a process of procurement of materials, a process of manufacturing component parts from the materials and a process of assembling the component parts. However, in many cases, only the assembling process using the component parts, which are manufactured outside, may be performed in their own facility. In this case, among the above-mentioned processes, the process of procurement of materials and the process of manufacturing component parts may be performed on the supplier's side.

Now, it is assumed that a manufacturing process on the supplier's side includes a plurality of processes to manufacture a particular component part, and the identical component part can be manufactured by any one of the processes. Specifically, for example, when manufacturing a “seal member”, the manufacturing process is carried out through an operation to cut a material such as a film material or a sponge material into a predetermined shape, an operation of punching, an operation of shaping such as bending, and an operation of finishing. It is assumed that, according to a process 1, the component part is manufactured by processing a material using a machinery A with respect to all operations. Moreover, it is assumed that, according to a different process 2, the operation of cutting and the operation of punching can be performed using machineries B and C, respectively, and the shaping operation and the operation of finishing are carried out according to manual operations of craftworkers. According to a further different process 3, the component part can be manufactured by carrying out only the operation of cutting using a machinery D and the operation of punching, the operation of shaping and the operation of finishing are carried out by a manual operation of craftworker. The identical component part can be manufactured finally according to any one of the processes 1, 2 and 3.

Usually, a manufacturer as an ordering party requests a competitive bid to a plurality of suppliers who can supply the identical component part in order to select one of the suppliers offering the lowest cost. Thus, each supplier selects a manufacturing process of a lowest cost so that the supplier can submit an estimation in which a cost is suppressed as low as possible. That is, if it is a case of the above-mentioned supplier, a possibility of selecting the above-mentioned process 1, which is considered to be the lowest cost, is high.

Moreover, depending on the supplier side, each supplier may have a different facility. For example, one supplier has state-of-art machinery A. In this case, it is highly possible that this supplier can manufacture the component part at the lowest cost and can supply the component part at the lowest cost. On the other hand, another supplier has only old-type machinery or does not have any machinery. In such a case, this supplier cannot manufacture the component part efficiently, thereby increasing a manufacturing cost. Thus, there is a low possibility for this supplier to supply the component part at a low cost. That is, it is highly possible that this supplier cannot receive an order because the supplier is at a heavy disadvantage in price competition.

However, in recent years, with rise in the environment-oriented activity and the energy-saving-orientated activity, it has become important to how to manufacture a product efficiently at a low cost in addition to that how well a manufacturer or a supplier can manufacture a product in consideration of an environment, that is, for example, while suppressing CO₂ emission.

Therefore, if a process (for example, the above-mentioned process 1) lacks consideration of an environment in a manufacturing process of a component part, a supplier may not use the process to manufacture the component part even when the cost of the component part manufactured by the process is low. On the contrary, if there is another process giving a high-degree of consideration of an environment, a possibility of manufacturing the component part according to the another process is high even when the cost of the product according to the another process is slightly high.

However, if the cost of the component part manufactured according to another process is too high, it is difficult for the supplier to manufacture the component part using the another process. This is because the supplier as a company cannot disregard a profit even if it is required to give consideration to an environment.

That is, the supplier selects a process to manufacture the component part according which the component part can be manufactured in consideration of a balance between a cost and an environmental consideration. Accordingly, it is desired to provide an apparatus or a tool which can easily recognize not only a cost but also an environmental value on an individual manufacturing process basis is desired.

On the other hand, if a supplier lacks consideration of an environment in a manufacturing process of a component part, a manufacturer may not make an order of the component part to the supplier even if the cost of the component part of the supplier is low. On the contrary, if there is another supplier providing a high-degree of consideration of an environment in the manufacturing process of the component part, a possibility of making an order to the another supplier is high even when the cost of the component part supplied by the another supplier is slightly high.

However, if the cost of the component part is too high, it is difficult for the manufacturer to make an order to another supplier. This is because the manufacturer as a company cannot disregard a commercial profit even if it is required to give consideration to an environment.

That is, the manufacturer selects a supplier to supply the component part in consideration of a balance between a cost and an environmental consideration. Accordingly, it is desired to provide an apparatus or a tool which can easily recognize not only a cost but also an environmental value on an individual supplier basis.

### SUMMARY OF THE INVENTION

It is a general object of the present invention to provide an information processing apparatus and method in which the above-mentioned problems are eliminated.

A more specific object of the present invention is to provide an information processing apparatus and method which can compute a manufacturing cost and an environmental value in accordance with a plurality of manufacturing processes based on a facility used.

In order to achieve the object, there is provided according to one aspect of the present invention an information processing apparatus configured to output a manufacturing cost and a CO₂ emission amount for each of manufacturing processes which is capable of manufacturing an identical product, the information processing apparatus including: a first storage part configured to store processing operation information in which the manufacturing processes, which can manufacture the identical product, are registered, wherein information regarding processing operations constituting each of the manufacturing processes, information regarding electric equipments used in each of the processing operations, information regarding a use time of each of the electric equipments for each of the processing operations, and a miscellaneous process cost excluding an electric power cost for each of the processing operations are also registered in said processing operation information by being associated with each other; a second storage part configured to store equipment information in which each of the electric equipments and a power consumption per unit time of each of the electric equipments are registered in association with each other; a third storage part configured to store electric power information in which an electric power cost per unit amount of electric power and a CO₂ emission amount per unit amount of the electric power are registered in association with each other; a process cost computation part configured to compute a power consumption consumed in each of the processing operations based on a use time in which one of the electric equipments is used and a power consumption of the one of the electric equipments per unit time, and compute a process cost required for each processing operation based on the power consumption, the electric power cost per unit amount of the electric power and the miscellaneous process cost; a processing CO₂ emission amount computation part configured to compute, for each manufacturing process, a processing CO₂ emission amount exhausted in each processing operation based on the power consumption and the CO₂ emission amount per unit amount of the electric power; a total cost computation part configured to compute a total cost including a process cost and a processing CO₂ emission amount required for a whole manufacturing process based on the process cost and said processing CO₂ emission amount of each of the processing operations; and an output part configured to output the total cost for each of the manufacturing processes.

There is provided another aspect of the invention an information processing method performed by an information processing apparatus configured to output a manufacturing cost and a CO₂ emission amount for each of manufacturing processes which is capable of manufacturing an identical product, the information processing method including: storing processing operation information in which the manufacturing processes, which can manufacture the identical product, are registered, wherein information regarding processing operations constituting each of the manufacturing processes, information regarding electric equipments used in each of the processing operations, information regarding a use time of each of the electric equipments for each of the processing operations, and a miscellaneous process cost excluding an electric power cost for each of the processing operations are also registered in said processing operation information by being associated with each other; storing equipment information in which each of the electric equipments and a power consumption per unit time of each of the electric equipments are registered in association with each other; storing electric power information in which an electric power cost per unit amount of electric power and a CO₂ emission amount per unit amount of the electric power are registered in association with each other; computing a power consumption consumed in each of the processing operations based on a use time in which one of the electric equipments is used and a power consumption of the one of the electric equipments per unit time, and compute a process cost required for each processing operation based on the power consumption, the electric power cost per unit amount of the electric power and the miscellaneous process cost; computing, for each manufacturing process, a processing CO₂ emission amount exhausted in each processing operation based on the power consumption and the CO₂ emission amount per unit amount of the electric power; computing a total cost including a process cost and a processing CO₂ emission amount required for a whole manufacturing process based on said process cost and said processing CO₂ emission amount of each of the processing operations; and outputting the total cost for each of the manufacturing processes.

Additionally, there is provided according to a further aspect of the present invention a non-transitory computer readable recording medium storing a program for causing an information processing apparatus to perform the above-mentioned information processing method.

It should be noted that it is effective for the mode of the present invention in which an arbitrary combination of the structural elements and expressions of the present invention are applied to a computer program or a non-transit computer readable recording medium storing a computer program.

According to the present invention, an information processing apparatus and method can compute a manufacturing cost and an environmental value in accordance with a plurality of manufacturing processes based on a facility used.

Other objects, features and advantages of the present invention will become more apparent from the following detailed description when read in conjunction with the accompanying drawings.

### BRIEF DESCRIPTION OF THE DRAWINGS

FIG. 1 is an illustration of a system according to a first embodiment of the present invention;

FIG. 2 is a block diagram of a hardware structure of a server according to the first embodiment;

FIG. 3 is a functional block diagram of the server according to the first embodiment;

FIG. 4 is an illustration of an example of manufacturing process information of A company;

FIG. 5 is an illustration of an example of manufacturing process information of B company;

FIG. 6 is an illustration of an example of manufacturing process information of C company;

FIG. 7 is an illustration of an example of facility information;

FIG. 8 is an illustration of an example of electric power information;

FIG. 9 is an illustration of an example of a selection standard;

FIG. 10 is a flowchart of information processing according to the first embodiment;

FIG. 11 is an illustration for explaining calculation of an electric power cost and a CO₂ emission in a process pattern (a) of A company;

FIG. 12 is an illustration indicating a total cost and an evaluation point in the process pattern (a) of A company;

FIG. 13 is an illustration indicating a total cost and an evaluation point in the process patterns (a), (b) and (c);

FIGS. 14A, 14B and 14C are evaluation point plot coordinates representations based on the selection standard;

FIG. 15 is a first example of a screen displayed on a terminal according to the first embodiment;

FIG. 16 is a second example of the screen displayed on the terminal according to the first embodiment;

FIG. 17 is a third example of the screen displayed on the terminal according to the first embodiment;

FIG. 18 is an illustration indicating a total cost and an evaluation point in each of process patterns selected from A, B and C companies;

FIG. 19 is a flowchart for explaining information processing according to a second embodiment;

FIGS. 20A, 20B and 20C are evaluation point plot coordinates representations based on the selection standard;

FIG. 21 is a first example of a screen displayed on a terminal according to the second embodiment;

FIG. 22 is a second example of the screen displayed on the terminal according to the second embodiment; and

FIG. 23 is a third example of the screen displayed on the terminal according to the second embodiment.

### DETAILED DESCRIPTION OF THE PREFERRED EMBODIMENTS

A description will be given below, with reference to the drawings, of embodiments of the present invention.

[System Structure]

(Entire Structure)

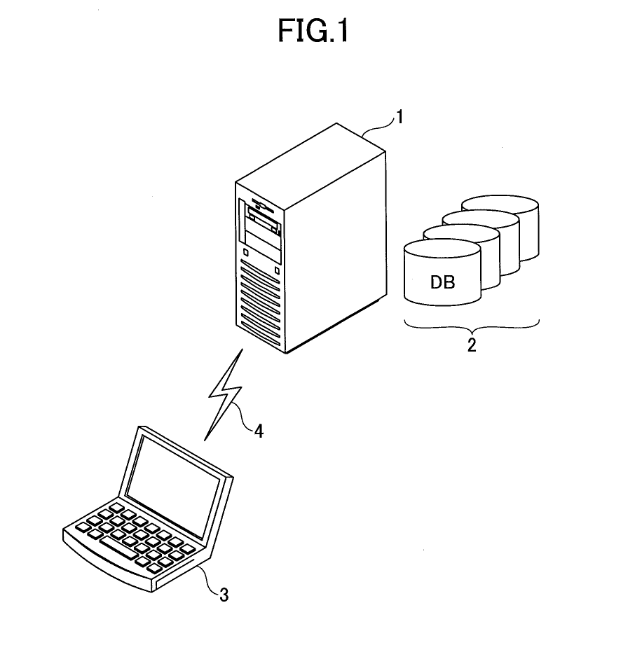

Before specifically explaining contents of the invention, a description is given of a structure of a system to carry out the present invention. FIG. 1 is a system structure according to a first embodiment of the present invention. As illustrated in FIG. 1, the system according to the first embodiment includes a server 1, a database (DB) 2 and a terminal 3, which are connected through a network 4.

The server 1 calculates or computes a cost and an environmental value (for example, CO₂ emission) of a component part to be manufactured for each component part manufacturing process (parts manufacturing process) of a supplier (parts supplier). The server 1 provides a result of calculation or computation to the terminal 3 which a user uses. The user uses the terminal 3 to access the server 1, and performs a predetermined operation. The above-mentioned result of computation is displayed on a screen of the terminal 3. Thus, the user can determine a component part manufacturing process (or a supplier to which an order of a component part is to be placed) while taking the cost and environmental value of the component part based on the result of computation. A detailed description will be given later.

The database (DB) 2 stores various kinds of information which are used by the server 1 to compute a cost and an environmental value (for example, CO₂ emission) of a component part to be manufactured by a component part manufacturing processes of each supplier. The DB 2 may include one or more data bases. The DB 2 will be described in detail with a specific example in detail later.

The terminal 3 is a client terminal which a user uses. Specifically, the terminal 3 may be a personal computer (PC), a portable information terminal, etc. The terminal 3 is connected to the server 1 through the network 4.

The network 4 is a communication transmission path which is realized by a Local Area Network (LAN), a Wide Area Network (WAN) (including a public line network, a dedicated line network, and the Internet network), etc., and is connected with the server 1 and the terminal 3.

In addition, because the server 1 is equipped with a display device or an input device, it is also possible for a user to directly operate the server 1 to perform an input operation instead of using the terminal 3.

(Hardware)

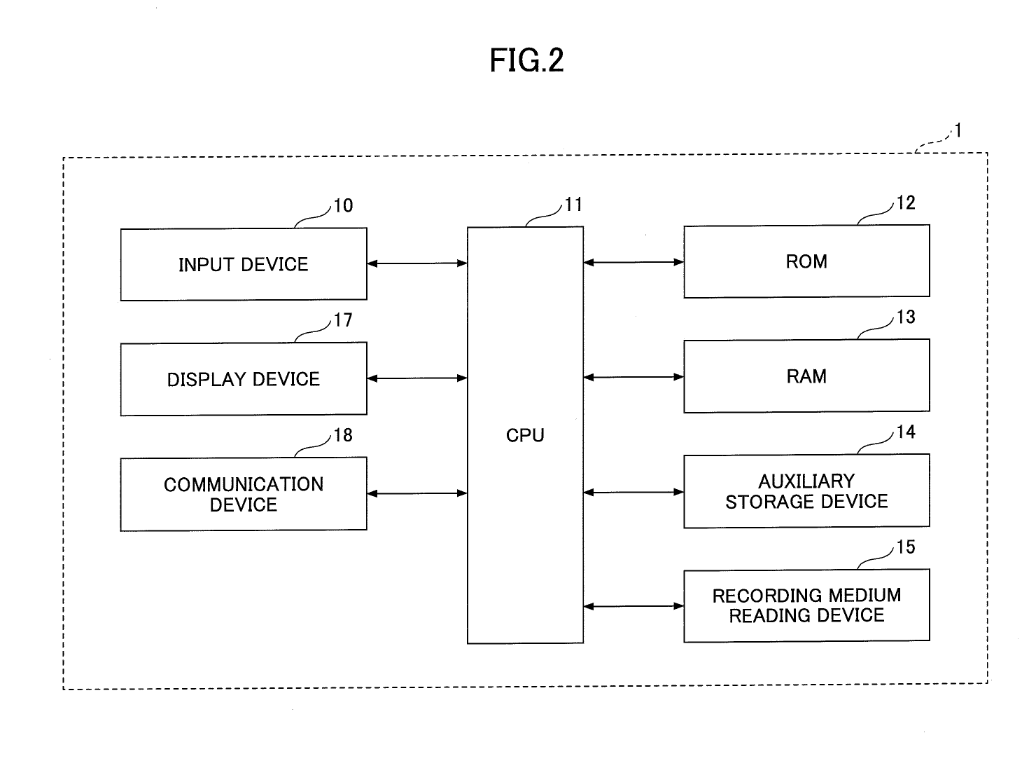

A description will be given of a hardware structure of the server 1 according to the first embodiment. FIG. 2 is a block diagram of a hardware structure of the server 1 according to the first embodiment. The server 1 includes a CPU (Central Processing Unit) 11, a ROM (Read Only Memory) 12, RAM (Random Access Memory) 13, an auxiliary storage device 14, a recording medium reading device 15, an input device 16, a display device 17, and a communication device 18.

The CPU 11 includes a microprocessor and its peripheral circuits in order to control the entire apparatus. Moreover, the ROM 12 stores a predetermined control program (software parts) executed by the CPU 11. The RAM 13 is used as a work area (work domain) by the CPU 11 when the CPU 11 performs various controls by executing various kinds of programs.

The auxiliary storage device 14 stores a general-purpose OS (Operating System), programs, and various kinds of information including data base. An HDD (Hard Disk Drive), which is a non-volatile storage device, may be used as the auxiliary storage device 14. The storage medium reading device 15 can acquire information from outside by a portable medium such as, for example, a USB memory, a CD, a DVD, etc., being set to the storage medium reading device 15.

The input device 16 is operated by a user to perform a various kinds of input operations. The input device 16 includes a mouse, a keyboard, a touch panel switch, etc. The touch panel switch is provided on and overlapped over a display screen of the display device 17. For example, the input device 16 includes, for example, an LCD (Liquid Crystal Display), a CRT (Cathode Ray Tube), etc. The communication device 18 performs communications with other devices through the network 4. The communication device 18 supports communications according to various kinds of network forms including a wired network or a wireless network.

The terminal 3 may be realized by a conventional personal compute (PC), a portable information terminal, or the like, and a description thereof is omitted.

(Function)

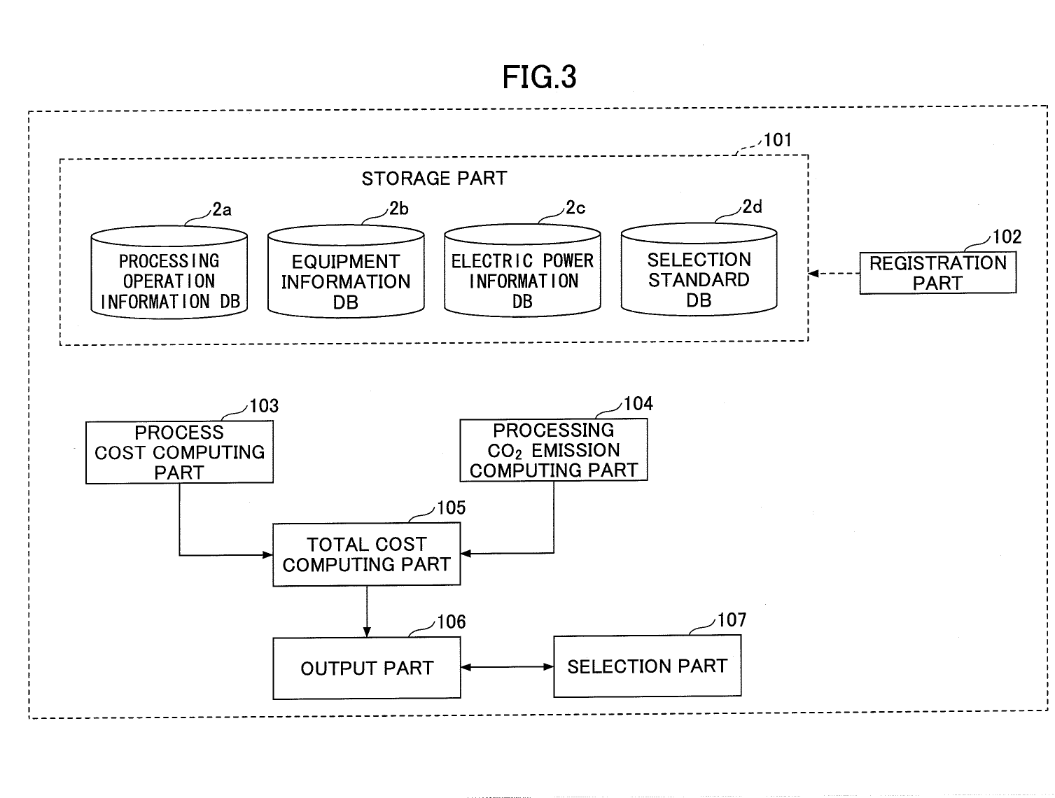

A description is given below of a functional structure of the server 1. FIG. 3 is a functional block diagram of the server 1 according to the present embodiment. As illustrated in FIG. 3, the server 1 includes as functions, a storage part 101, a registration part 102, a process cost computing part 103, a processing CO₂ emission computing part 104, a total cost computing part 105, an output part 106, and a selection part 107.

The storage part 101 is realized by, for example, the above-mentioned hard disk drive (HDD) or the like to store information in the DB 2, the information including processing operation information DB 2a, facility information DB 2b, electric power information DB 2c, and a selection standard DB 2d, which are described in detail with a specific example later. The processing operation information DB 2a, the facility information DB 2b, the electric power information DB 2c, and the selection standard DB 2d may be collectively referred to as “DB 2”.

The registration part 102 registers beforehand various kinds of information stored in the DB 2 of the storage part 101. That is, the DB 2 is used upon storage of necessary kinds of information in the registration part 102

The process cost computing part 103 computes a process cost required for each processing operation (process cost money) for each registered manufacturing process (process pattern) by referring to the above-mentioned DB 2 when manufacturing a product (for example, a component part). For example, when manufacturing a component part, the manufacturing process includes one or more processing operations. Thus, the process cost computing part 103 computes a process cost required for each processing operation. A specific computing method will be described later.

The processing CO₂ emission computing part 104 computes a CO₂ emission exhausted by each processing operation (hereinafter, referred to as processing CO₂ emission) for each of registered manufacturing processes by referring to the above-mentioned DB 2 in association with the process cost necessary for each process cost being computed by the process cost computing part 103. For example, although, when manufacturing a component part, the manufacturing process includes one or more processing operations, the processing CO₂ emission computing part 104 computes a CO₂ emission exhausted by each of the processing operations. A specific computing method will be described later.

The total cost computing part 105 computes a total cost including a process cost and a manufacturing CO₂ emission required by an entire manufacturing process based on the process cost computed by the process cost computing part 103 and the processing CO₂ emission computed by the processing CO₂ emission computing part 104. For example, when manufacturing a component part, a process cost necessary for each processing operation is computed by the process cost computing part 103. Thus, when computing the CO₂ emission of the entire manufacturing process, the CO₂ emissions of all processing operations are summed. The cost mentioned here may mean a burden, which includes not only a money cost to be required when manufacturing a component part but also a CO₂ emission.

The output part 106 outputs the total cost computed by the total cost computing part 105 for each of all manufacturing processes registered. Moreover, the output part 106 outputs one of the manufacturing processes selected by the selection part 107. The output mentioned here includes various operation forms such as, for example, transmitting information to the server 1 or the terminal 3 through the network 4, outputting and displaying on a display device of the server 1 or the terminal 3, or print-outputting to a printing device, etc. That is, information according to various kinds of formats may be output to the user so that the user can recognize the output.

The selection part 107 selects an appropriate one of a plurality of manufacturing processes of which total cost is output by the total cost computing part 105 by referring to the selection standard 2d. That is, the selection part 107 selects recommended one of the manufacturing processes to the user in consideration of a necessary total cost (including a manufacturing cost and a CO₂ emission). As an example, an ideal manufacturing process is capable of manufacturing a product at the lowest manufacturing cost and the lowest CO₂ emission. However, because such an ideal manufacturing process does not always exist, the selection part 107 selects one of the limited number of manufacturing processes, which one is preferably recommendable, to the user according to the selection standard 2d.

In addition, those functions explained above are realized practically by programs executed by the CPU 11.

(Processing Operation Information DB 2a)

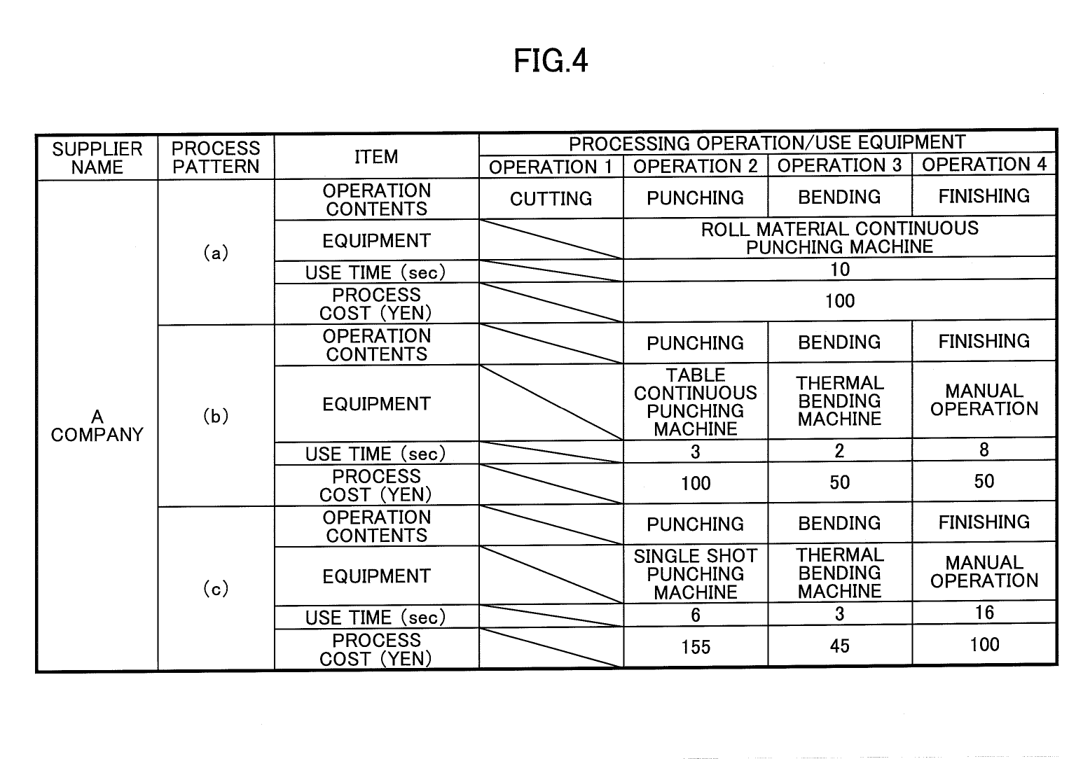

FIGS. 4 through 6 illustrate examples of processing operation according to the present embodiment. FIGS. 4 through 6 indicate processing operation information when manufacturing a “seal member” which is an example of a processing product. Moreover, FIG. 4 through 6 indicate processing operation information of supplies, A company, B company and C company, respectively. A description will be given of FIG. 4 as a representative example.

“SUPPLIER NAME” indicates a name of a supplier. “PROCESS PATTERN” indicates, when manufacturing a product such as a “seal member”, a manufacturing process which can be use to manufacture the identical product, “seal member”. That is, for example, in A company, the “seal member” can be manufactured (processed) according to three patterns, that are (a), (b) and (c). Accordingly, A company can manufacture the identical “seal member” by using any one of the process patterns (a), (b) and (c). The differences are in operations and equipments used in each operation.

“ITEM” includes “OPERATION CONTENTS”, “EQUIPMENT”, “USE TIME (sec)”, and “PROCESS COST (YEN)”. These items correspond to “operations” (for example, operations 1-4), and indicate “operation contents”, “equipment”, “use time (sec)”, and “PROCESS COST (yen)”.

The “PROCESS CONTENTS” indicates contents of a specific process when manufacturing the “seal member”. For example, in the “PROCESS CONTENTS”: (a), the “seal member” is manufactured by the processing operations including punching, bending and finishing.

“EQUIPMENT” indicates equipments that are used in each processing operation (particularly, an electric equipment requiring electric power). For example, in the “PROCESS PATTERN”: (a), it is appreciated that sheet cutting, punching, bending and finishing are performed by using a roll material continuous punching machine.

“USE TIME (sec)” indicates a use time (required time) during which the equipment is used for each processing operation. The unit of the use time is a second. For example, in the “PROCESS PATTERN”: (a), a roll material punching machine is used in the whole manufacturing process, and it is appreciated that the use time is 10 seconds. In other words, the “seal member” can be manufactured in 10 seconds when using the roll material punching machine.

“PROCESS COST (YEN)” indicates a cost required for each processing operation. However, an electric power cost used by equipments is excluded (because an electric power used by equipments is computed separately). Specifically, “PROCESS COST (YEN)” includes, in addition to a labor cost directly associated with processing, a depreciation cost, an allocated cost (labor cost and expense of a product management department and a quality management department), a consumable cost, an indirect material cost, a place expenditure, etc. (referred to as a miscellaneous expense). For example, in the “PROCESS PATTERN”: (b), a product is not manufactured continuously in a single equipment as is in (a). That is, it is appreciated that the “seal member” is manufactured by performing punching, bending and finishing one by one. For example, in the “PROCESSING OPERATION”: (a), 100 yen is required for whole manufacturing process.

It should be noted that in the “PROCESS PATTERN”: (b), the product is not manufactured continuously by a single equipment as is in (a).

That is, it is appreciated that the “seal member” is manufactured by performing punching, bending and finishing one by one. Then, because used equipment differs from the operation 2 to the operation 3 (finishing is a manual operation by a craftworker), “USE TIME” and “PROCESS COST” also differ.

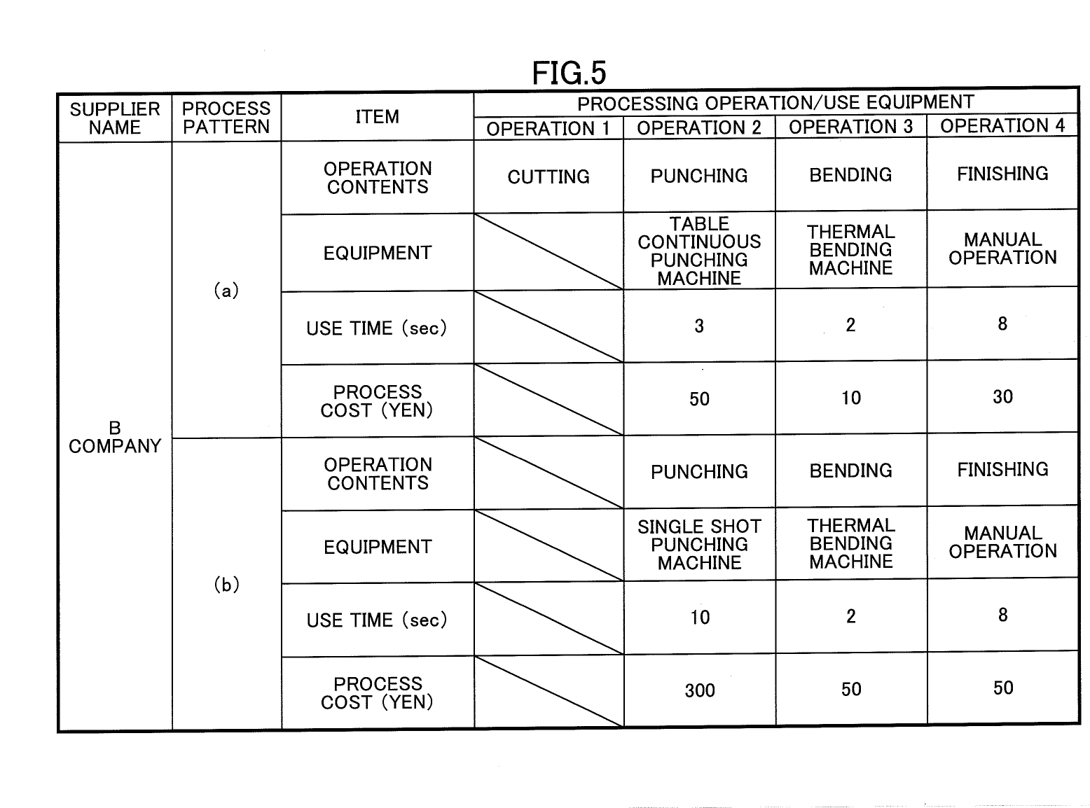

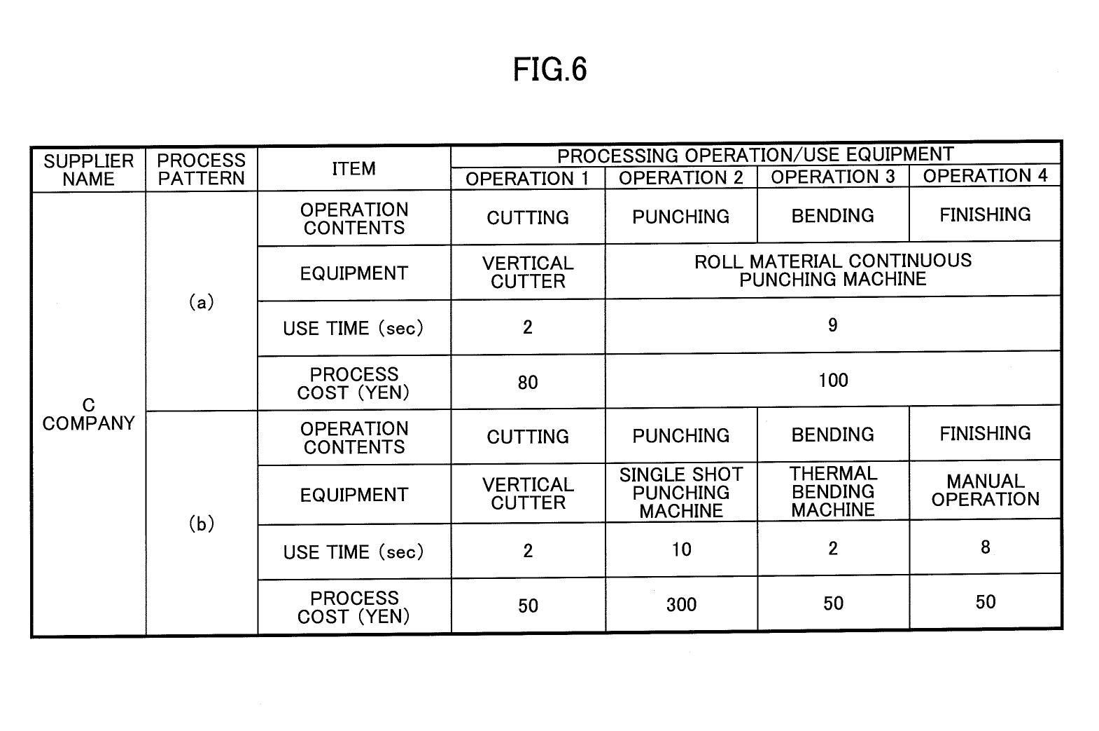

On the other hand, referring to FIGS. 5 and 6, it is appreciated that A company can manufacture (process) the “seal member” according to two patterns, that are (a) and (b). This is based on various conditions such as, for example, owned equipments, degree of skill of craftworkers, processing efficiency, etc.

Although the processing operation information DB 2a illustrated in FIGS. 4 through 6 indicates only the processing operation information regarding the “seal member”, processing operation information for each of other component parts is registered in the processing operation information DB 2a.

(Equipment Information DB 2b)

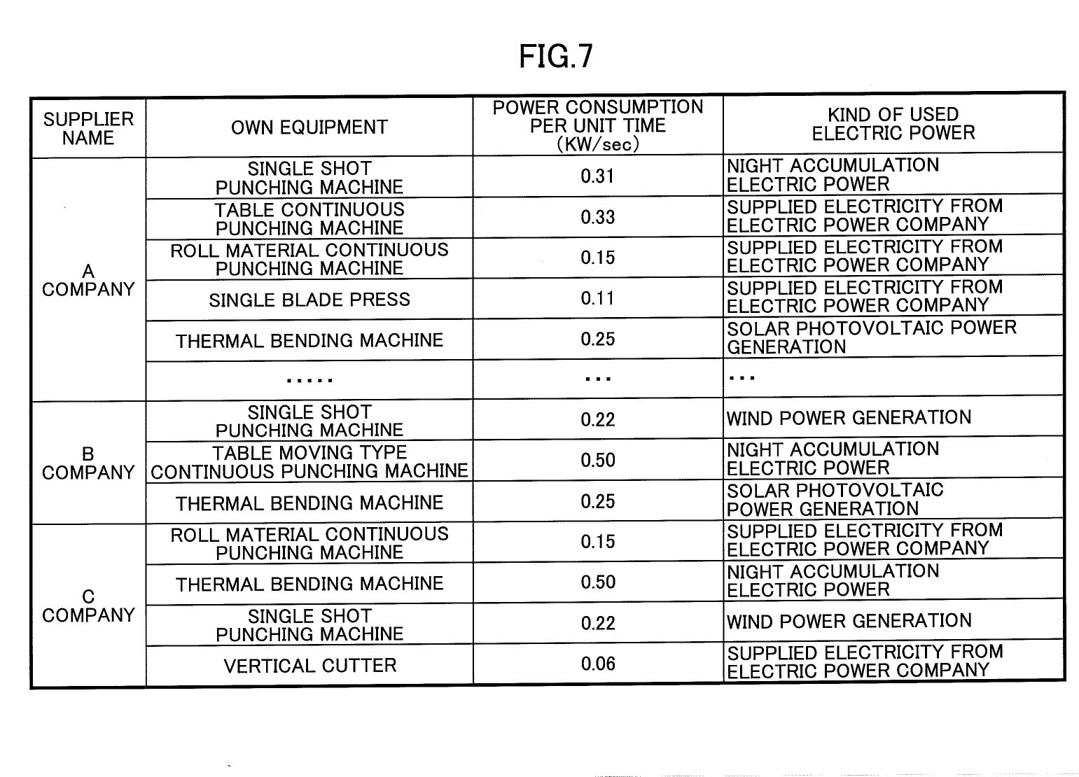

FIG. 7 illustrates an example of the equipment information DB 2b according to the present embodiment. Information regarding equipments owned by A company, B company and C company is registered in the equipment information DB 2b.

“SUPPLIER NAME” indicates a name of a supplier. “OWN EQUIPMENT” indicates equipment owned by a supplier. The own equipment is in a corresponding relationship with the “EQUIPMENT” the processing operation information DB 2a. “POWER CONSUMPTION PER UNIT TIME (KW/sec)” indicates a power consumption per unit time (sec) when the own equipment is used. “KIND OF ELECTRIC POWER” indicates a kind of electric power used by each own equipment. “KIND OF USED ELECTRIC POWER” indicates a kind of electric power used by the own equipment.

For example, it can be appreciated from FIG. 7 that the A company has a single shot punching machine as “OWN EQUIPMENT” of which power consumption is 0.31 KW per 1 second, and the A company uses a night accumulation electric power when operating the single shot punching machine.

(Electric Power Information DB 2c)

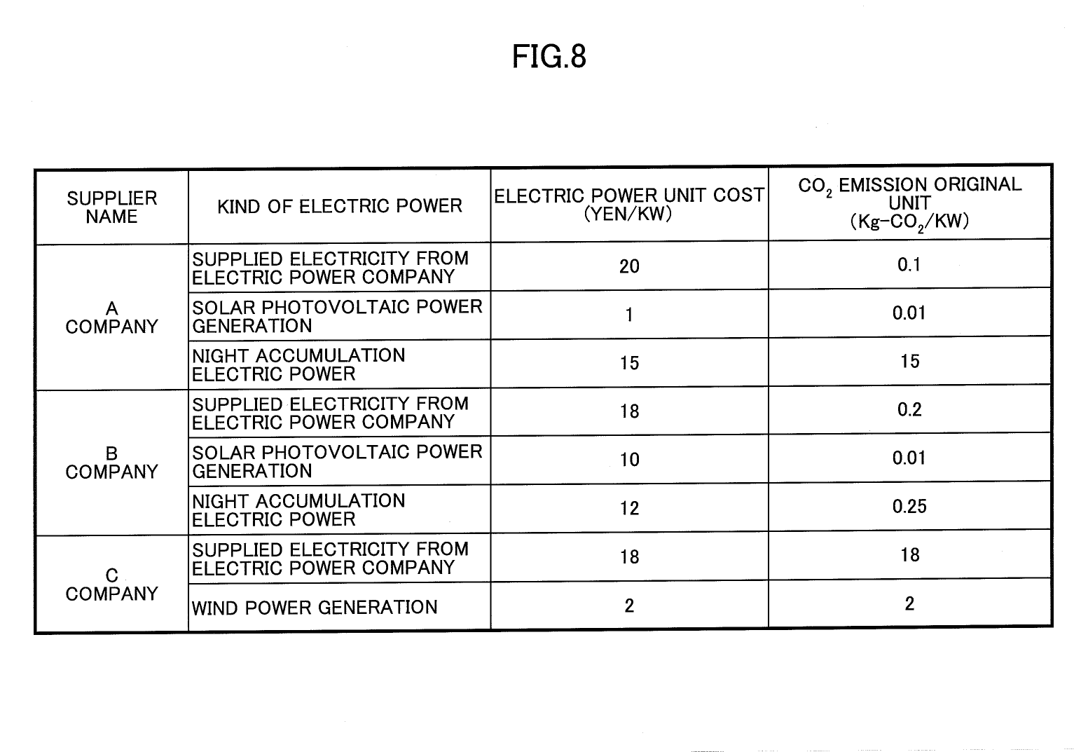

FIG. 8 illustrates an example of the electric power information DB 2c according to the present embodiment. Information regarding electric power is registered in the electric power information DB 2c for each kind of electric power and for each of A company, B company and C company.

“SUPPLIER NAME” indicates a name of a supplier. “KIND OF ELECTRIC POWER” indicates a kind of electric power which each supplier uses. The kind of electric power has a correspondence relationship with the “KIND OF USED ELECTRIC POWER” of the equipment information DB 2b. “ELECTRIC POWER UNIT COST (YEN/KW)” indicates an electric power cost per 1 KW. “CO₂ EMISSION ORIGINAL UNIT (kg/CO₂/KW)” indicates a CO₂ emission per unit of 1 KW.

For example, it is appreciated from FIG. 8 that the A company uses an electric power supply from an electric power company, a solar photovoltaic electric power, and a night accumulation electric power as the “kind of electric power” used by the A company. It is also appreciated that if the “kind of electric power” indicates a supply electric power from an electric power company, a cost of 20 yen per 1 KW is required and CO₂ is exhausted at 0.1 Kg-CO₂ per 1 KW. It should be noted that 20 yen per 1 KW is impractical money, and, practical money may be smaller than that. In the present embodiment, 20 yen is set for the sake of convenience.

(Selection Standard DB 2d)

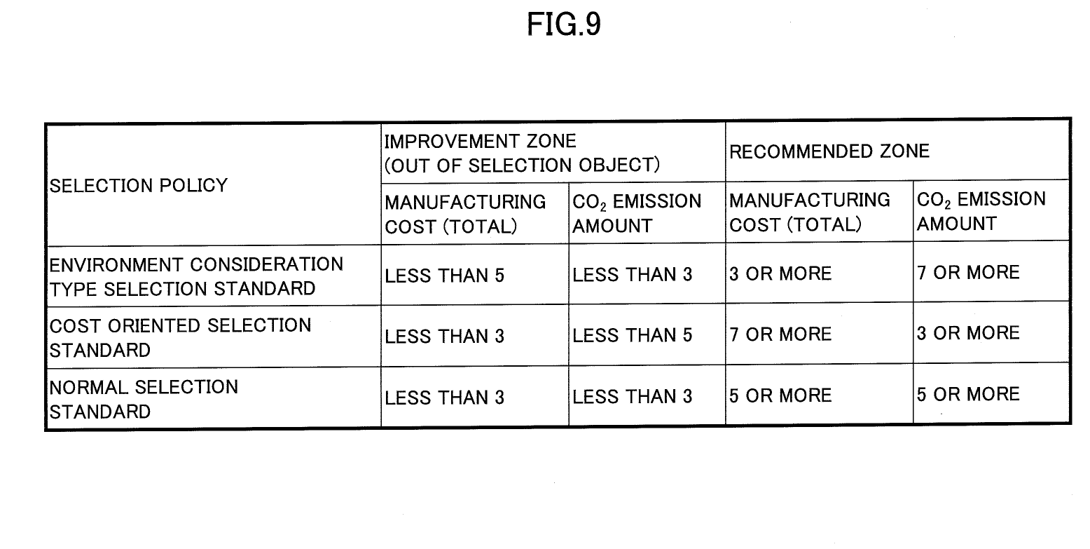

FIG. 9 illustrates an example of the selection standard DB 2d according to the present embodiment. The selection standard DB 2d stores information used when selecting one of a plurality of manufacturing processes recommendable to a user. The selection standard DB 2d according to the present embodiment is provided with selection standards such as “ENVIRONMENT CONSIDERATION TYPE SELECTION STANDARD”, “COST ORIENTED SELECTION STANDARD” and “NORMAL SELECTION STANDARD” as illustrated in FIG. 9. Then, a parameter “evaluation point” mentioned later is defined for each of the standards. A specific use form of the parameter will be described later.

In the present embodiment, each value in the DB 2 is known information, and each value can be computed as follows. That is, first, a processing operation is set based on a processing condition (drawing specification, processing environment of a supplier). Then, systemizing the logic of a cost table for calculating a cost based on the set processing operation so that an electric power and CO₂ emission can be computed if the drawing specification is known.

For example, an example of the seal member is given. The following standards are previously set in the cost table for seal;

A processing operation uses a single shot punching machine when a longitudinal dimension of the seal is 150 mm or less, and uses a continuous punching machine when the longitudinal dimension is more than 150 mm (by having a plurality of standards, the processing operation of the seal is determined for each supplier). Punching equipment operation time (required time) with respect to the longitudinal size 1 takes 1 second/mm. Then, if a specific longitudinal dimension in the drawing is found, an equipment to be used and a time to perform processing are determined.

Additionally, in association with the equipment determined in the above-mentioned manner, an logical power consumption for each supplier, an electric power demand rate, and CO₂ conversion formula are determined for each equipment previously set by the cost table. Further, expenses per expense item are calculated using the equipment operation time (required time) calculated from the drawing specification as follows:
An electric power expense (yen) (electric power cost per one piece of component part):

Electric power cost(yen)=power consumption(KW)×electric power unit cost(yen/KW)
a contract value with an electric power company for each supplier.

Power consumption(KW)=power consumption rate(KW/sec)×equipment operation time(sec)

Power consumption rate(KW/sec)=logical power consumption(KW/H)×electric power demand(%)× 1/60
CO₂ emission (Kg-CO₂)

CO₂ emission(kg-CO₂)=power consumption(KW)×CO₂ conversion formula(kg-CO₂/KW)

Power consumption(KW)=power consumption rate(KW/sec)×equipment operation time(sec)

Power consumption rate(KW/sec)=logical power consumption(KW/H)×electric power demand(%)× 1/60

Similar to the above, a labor cost and an equipment cost per one piece of component part are computed.

Labor cost(yen):(equipment operation time (sec)÷number of owned equipment)×cost per hour(yen/sec)

Labor cost(yen): equipment operation time(sec)×equipment cost per hour(yen/sec)

The process cost can be acquired by summing the above-mentioned expenses.

### First Embodiment

A description will be given of an information processing of the server 1 according to the present embodiment. As mentioned above, when the A company manufactures the “seal member”, which is a processed product, the “seal member” can be manufactured (processed) according to the three patterns, that are the process patterns (a), (b) and (c). The A company can manufacture the identical “seal member” by adopting any one of the process patterns (a), (b) and (c). Here, a description is given of a case where the server 1 selects an appropriate manufacturing process from among the process patterns (a), (b) and (c). That is, the server 1 selects one of the manufacturing processes recommendable to a user from among the plurality of manufacturing processes of the “seal member” in the A company in consideration of a necessary whole cost (including a MANUFACTURING COST and CO₂ emission).

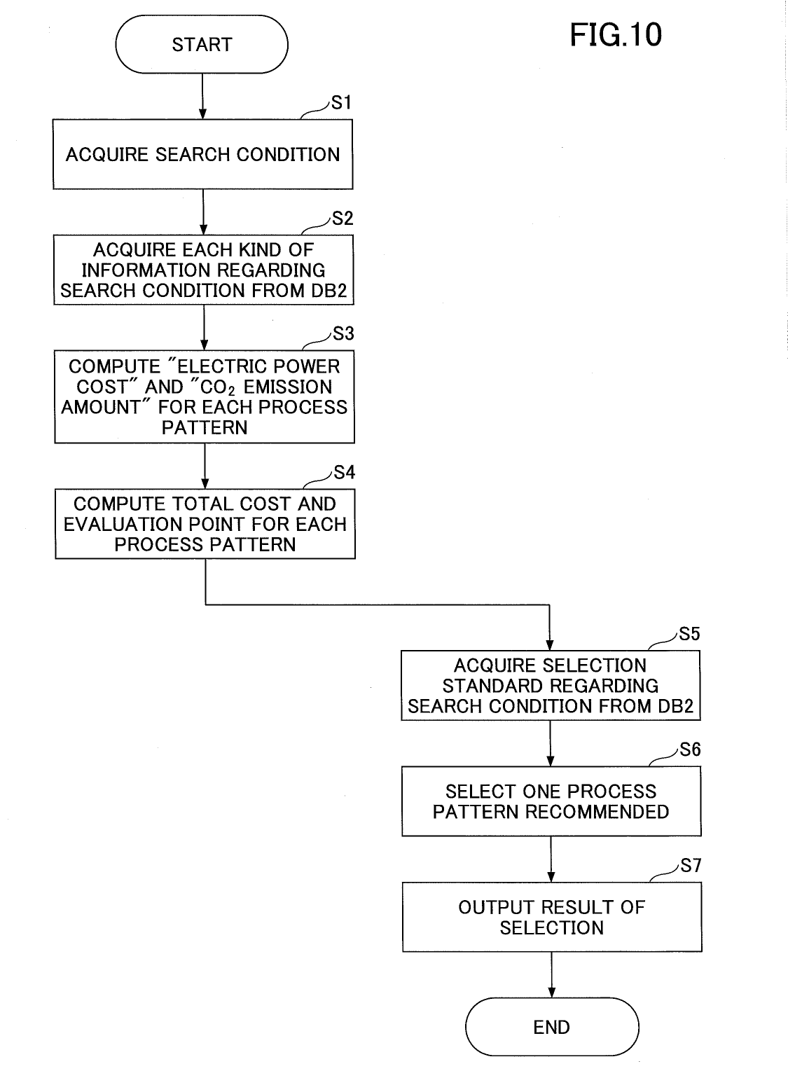

FIG. 10 is a flowchart for explaining the information processing according to the present embodiment. As mentioned above, various kinds of necessary information is stored in the DB 2 (the processing operation information DB 2a, the equipment information DB 2b, the electric power information DB 2c, the selection standard DB 2d) by the registration part 102. A description is given below of the process performed by the server 1 by dividing the process into situations, a computing process and a selecting process.

(Computing Process)

First, in step S1, the server 1 acquires a search condition input thereto. The search condition is input by a user, for example, through the terminal 3 or the like. Here, as a search condition, the condition of the “seal member”, the “A company” and the “environment consideration selection standard” are input in order to select a recommendable one of the manufacturing processes when the A company manufactures the “seal member”. The “environment consideration type selection standard” will be explained later.

Then, in step S2, the server 1 acquires various kinds of information regarding the search condition from the DB 2. Specifically, the server 1 acquires “operation contents”, “equipment”, “use time (sec)” and “process cost (yen)” from the processing operation information DB 2a (FIG. 4) using the “A company” and the “seal member” as a keyword from among the search conditions for each of the process patterns (a), (b) and (c) of the A company. Additionally, the server 1 acquires “owned member of equipments”, “power consumption per unit time (KW/sec)” and “kind of electric power used” from the equipment information DB 2b (FIG. 7). Moreover, the server 1 acquires “kind of electric power”, “electric power unit cost (yen/KW)”, and “CO₂ emission original unit COST (Kg-CO₂/KW)” from the electric power information DB 2c (FIG. 8). It should be noted that in the processing operation information DB 2a according to the present invention, only the processing operation information with respect to the “seal member”. However, it should be recognized that processing operation information is registered corresponding to other component parts.

Then, in step S3, the server 1 (manufacturing cost computing part 103 and the processing CO₂ emission computing part 104) computes the “ELECTRIC POWER COST” and the “CO₂ emission” for each process pattern.

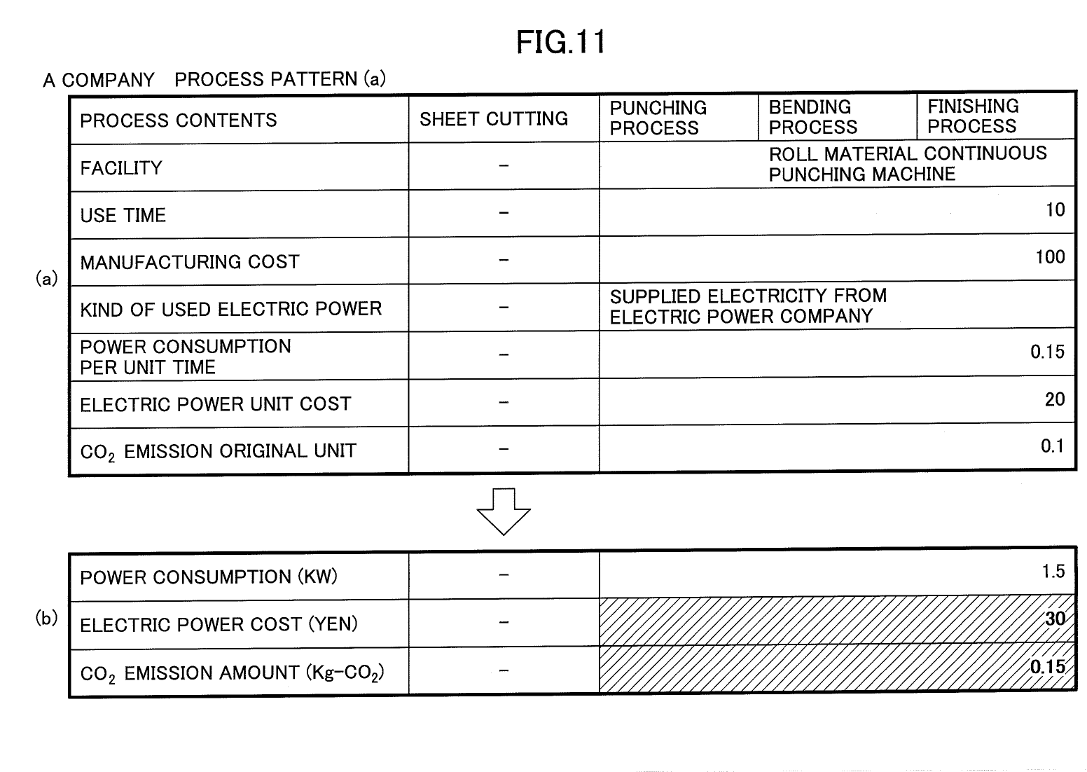

FIG. 11 is an illustration for explaining the computation of an electric power cost and the CO₂ emission amount in the process pattern (a) of the A company.

FIG. 11-(a) indicates information regarding the process pattern (a) of the A company when the A company manufactures the “seal member”. Specifically, the table of FIG. 11-(a) is created based on the above-mentioned step S2.

Referring to FIG. 11-(b), the “ELECTRIC POWER COST” can be computed as 1.5 KW by multiplying the “USE TIME”=10 seconds and the “POWER CONSUMPTION PER UNIT TIME”=0.15 KW of FIG. 11-(a). Moreover, the “ELECTRIC POWER COST” can be computed as 30 (yen) by multiplying the “POWER CONSUMPTION”=1.5 of FIG. 11-(b) and the “CO₂ EMISSION ORIGINAL UNIT COST” (0.1) of FIG. 11-(a). Further, the “CO₂ EMISSION” can be computed as 0.15 (Kg-CO₂) by multiplying the “POWER CONSUMPTION”=1.5 of FIG. 11-(b) and the “CO₂ EMISSION ORIGINAL UNIT COST”=0.1 of FIG. 11-(a).

As mentioned above, if the A company adopts the process pattern (a) when manufacturing the “seal member”, the cost at that time can be computed as the “ELECTRIC POWER COST”=30 (yen) and the “CO₂ EMISSION AMOUNT”=0.15 (Kg-CO₂). The cost of each of the process patterns (b) and (c) can be computed in the identical manner as the process pattern (a) mentioned above.

Then, in step S4, the server 1 (the total cost computing part 105) computes a total cost and an evaluation point for each process pattern.

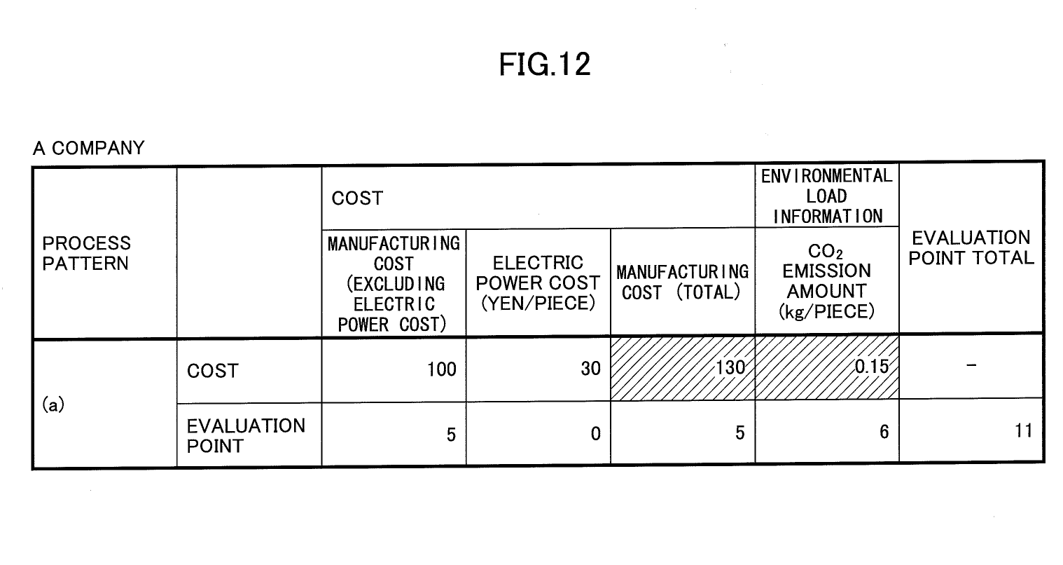

FIG. 12 is an illustration indicating a total cost and an evaluation point in the process pattern (b) of the A company. In the figure, “MANUFACTURING COST (EXCLUDING ELECTRIC POWER COST)” is acquired from FIG. 11-(a), and a value thereof is 100 (yen). Moreover, the “ELECTRIC POWER COST” is computed as 30 (yen). Thus, the “MANUFACTURING COST (TOTAL)”=130 (yen) includes the above-mentioned miscellaneous cost=100 (yen) and the electric power cost (electricity cost)=30 (yen) used when the equipment (roll material continuous punching machine) is used.

In the present embodiment, the “ELECTRIC POWER COST” corresponding to the “KIND OF ELECTRIC POWER” is reflected in the computation of the “ELECTRIC POWER COST” in consideration of the “KIND OF ELECTRIC POWER”. Electric power is generated by various methods (for example, refer to FIG. 7). An electric power unit cost (for example, refer to FIG. 8) differs depending on the methods of generating electric power. Thus, the computed “ELECTRIC POWER COST” can be more accurate by considering the “KIND OF ELECTRIC POWER” when computing the “ELECTRIC POWER COST”.

Moreover, in FIG. 12, the “CO₂ EMISSION AMOUNT” is computed as 0.15(Kg-CO₂). This “CO₂ EMISSION AMOUNT”=0.15(Kg-CO₂) is an amount of CO₂ exhausted when the A company adopts the process pattern (a) in the case of manufacturing the “seal member”. That is, the equipment (roll material continuous type punching machine) is used when manufacturing the “seal member”, and the “CO₂ EMISSION AMOUNT”=0.15(Kg-CO₂) is an amount of CO₂ exhausted from operations of the equipment.

It should be noted that when computing the “CO₂ EMISSION AMOUNT” in the present embodiment, the “KIND OF ELECTRIC POWER” is taken into consideration and the “CO₂ EMISSION AMOUNT” corresponding to the “KIND OD ELECTRIC POWER” is reflected. As mentioned above, in order to more improve the accuracy of the computed “ELECTRIC POWER COST”, an electric power used (consumed) is included in the logic of computing the cost.

Moreover, “EVALUATION POINT” is given to each item in FIG. 12. The “EVALUATION POINT” is given as a result of evaluation of each item. The value is greater as the evaluation is higher. Here, as the evaluation value, 5 points are given to the “MANUFACTURING COST (EXCLUDING ELECTRIC POWER COST)”=100 (yen), 0 point is given to the “CO₂ EMISSION AMOUNT”, 5 points are given to the “MANUFACTURING COST (TOTAL)”=130 (yen), and 6 points are given to the “CO₂ EMISSION AMOUNT”=0.15 (Kg-CO₂). Thus, the “EVALUATION POINTS TOTAL” is 11 points by summing 5 points of the “MANUFACTURING COST (TOTAL)” and 6 points of the “CO₂ EMISSION AMOUNT”.

As to a method of giving the “EVALUATION POINT”, there are the following methods.

(1) Evaluation Method Using an Absolute Value Decided Beforehand Simply

The degree of achievement to the value at this time is evaluated using a past actual result or a bench marking value and a value decided based on a numerical value such as an increase or decrease in a year-on-year ratio (%). For example, 5 points are given if the “MANUFACTURING COST (TOTAL)” is 130 yen to 127 yen, 6 points if 127 yen to 124 yen, 7 points if 124 yen to 121 yen, 8 points if 121 yen to 198 yen.

(2) Evaluation According to Deviation Value

Points are given to a difference from a mean value. A higher accuracy is achieved as compared to a ranking method, thereby giving an appropriate evaluation point.

(3) Relative evaluation according to ranking

A higher point is given in an order of a better value.

The evaluation according to the deviation value or a relative evaluation can be used when the “MANUFACTURING COST (TOTAL) and “CO₂ emission amount” is computed over a plurality of process patterns or a plurality of companies.

As mentioned above, the MANUFACTURING COST (including an electric power cost) and the CO₂ emission amount in the process pattern (a) of the A company is computed. Additionally, the evaluation point is also given. The MANUFACTURING COST (including an electric power cost) and the CO₂ emission amount in each of the process patterns (b) and (c) are computed in the same manner as the process pattern (a), and also an evaluation point can be given.

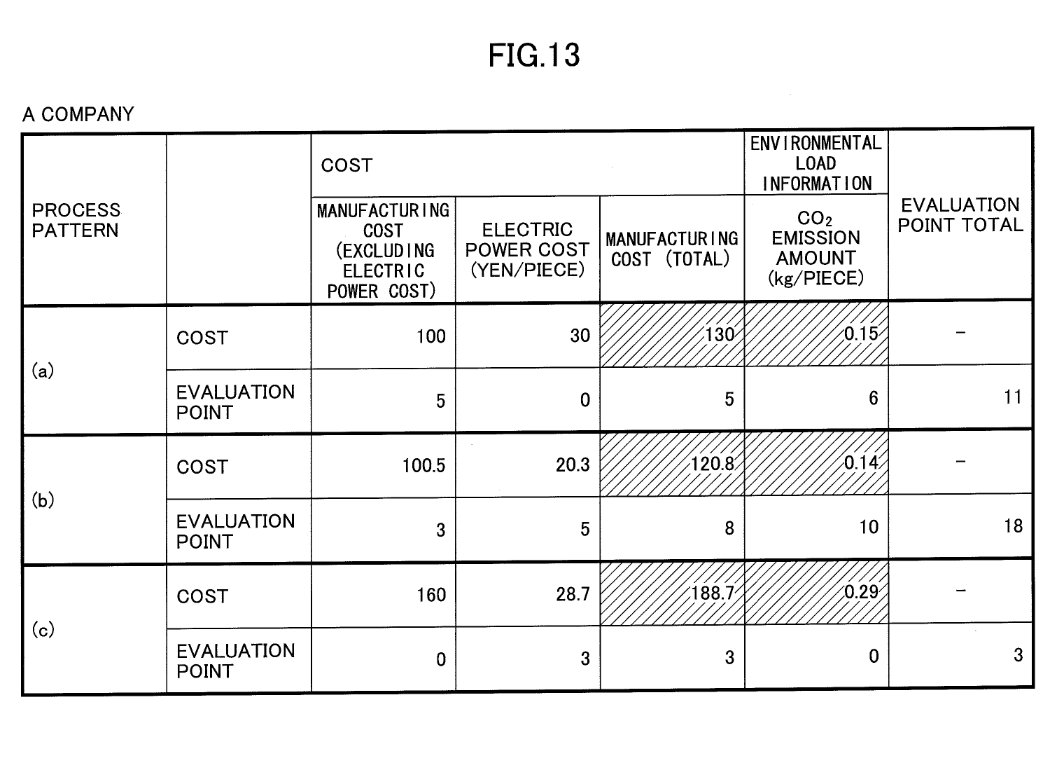

FIG. 13 is an illustration indicating a total cost and an evaluation point in the process patterns (a), (b) and (c) of the A company. Specifically, a total cost and an evaluation point in the process patterns (b) and (c) are indicated in addition to that in the process pattern (a). The A company can manufacture (process) the identical “seal member” according to the three patterns, that are process patterns (a), (b) and (c). FIG. 13 is a list of “MANUFACTURING COST (TOTAL)”, the “CO₂ EMISSION AMOUNT” and the “EVALUATION POINT” for each process pattern.

(Selection Process)

Returning to FIG. 10, in step S5, the server (the selection part 107) acquires from the DB 2 a selection standard regarding search condition. Specifically, the server 1 acquires the “MANUFACTURING COST (TOTAL)” and the “CO₂ EMISSION AMOUNT” of the “IMPROVEMENT ZONE” and the “RECOMMENDED ZONE” of the “ENVIRONMENT CONSIDERATION TYPE SELECTION STANDARD” from the selection standard DB 2d using the “ENVIRONMENT CONSIDERATION TYPE SELECTION STANDARD” as a key. The server 1 selects one of the manufacturing processes recommendable to the user based on the selection standard DB 2d from among the three patterns, which are the process patterns (a), (b) and (c).

Then, in step S6, the server 1 (the selection part 107) selects recommendable one of the process patterns from the plurality of process patterns. A description will be given below of this point in detail.

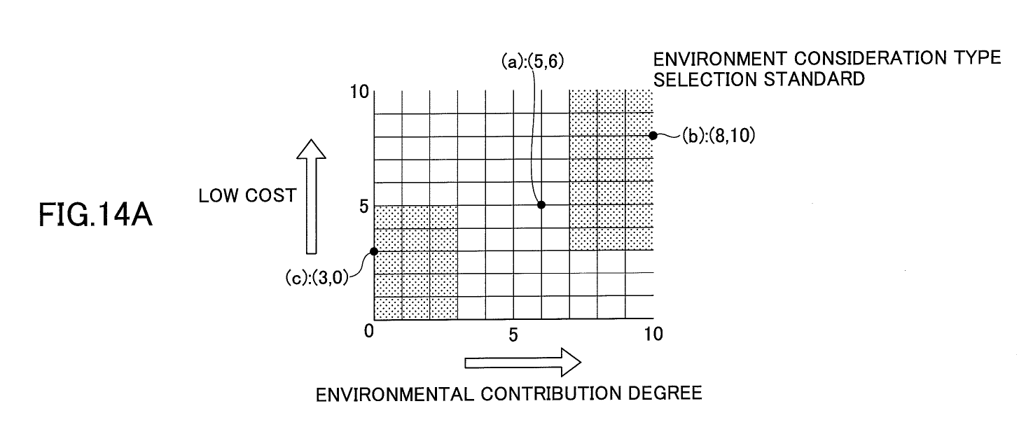

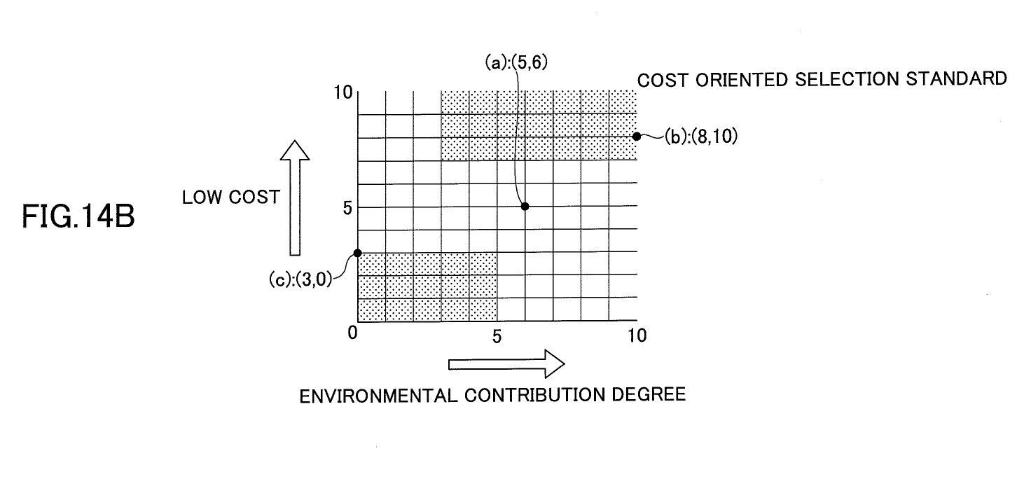

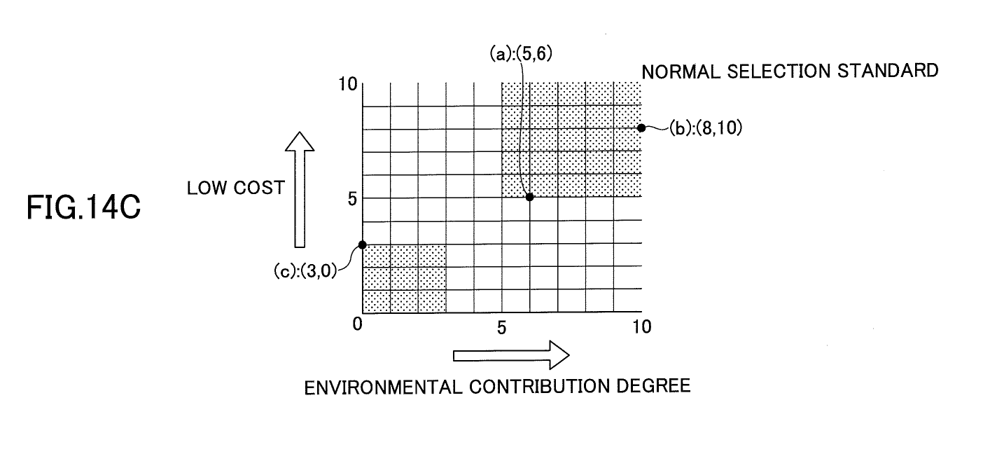

FIGS. 14A, 14B and 14C are evaluation standard point plot coordinates tables based on the selection standard DB 2d. Referring now to the selection standard DB 2d of FIG. 9, items of the “IMPROVEMENT ZONE” and “RECOMMENDED ZONE” are provided for each selecting policy (selection standard). Additionally, items of the “MANUFACTURING COST (TOTAL)” and the “CO₂ EMISSION AMOUNT” are provided. Values indicated in the items correspond to the above-mentioned evaluation points.

For example, in the case of the “ENVIRONMENT CONSIDERATION SELECTION STANDARD”, standard values of the “IMPROVEMENT ZONE” are the “MANUFACTURING COST (TOTAL)”=less than 5 and the “CO₂ EMISSION AMOUNT”=less than 3. This means that, when an evaluation point of a manufacturing process is plotted in the improvement zone, it is not appropriate to select the manufacturing process as a manufacturing process recommendable to the user. Moreover, standard values of the “RECOMMENDED ZONE” are the “MANUFACTURING COST (TOTAL)”=3 or more and the “CO₂ EMISSION AMOUNT”=7 or more. This means that, when an evaluation point of a manufacturing process is plotted in the recommended zone, it is to be selected as a manufacturing process recommended to the user.

Referring to FIG. 14A, the “IMPROVEMENT ZONE” and the “RECOMMENDED ZONE” are clearly indicated in the evaluation point plot coordinates table based on the “ENVIRONMENT CONSIDERATION TYPE SELECTION STANDARD”. Then, from the above mentioned result of computation, the evaluation points (“MANUFACTURING COST (TOTAL)”. “CO₂ EMISSION AMOUNT”) with respect to the “MANUFACTURING COST (TOTAL)” and “CO₂ EMISSION AMOUNT” of the process patterns (a), (b) and (c) are expressed as (a): (5.6), (b): (8.10) and (c): (3.0) (refer to FIG. 13). Accordingly, the evaluation points given to the above-mentioned process patterns (a), (b) and (c) are plotted on the coordinates.

In the selection standard DB 2d, the standard values of the “IMPROVEMENT ZONE” and the “RECOMMENDED ZONE” are determined so that an importance is given to an environmental consideration rather than a cost. That is, the standard values are determined so that a manufacturing process is worth of selection if its environmental consideration is high even if a cost is high in some degrees. Then, “NORMAL SELECTION STANDARD” is a selection standard in the middle therebetween.

Here, in the case of “ENVIRONMENT CONSIDERATION TYPE SELECTION STANDARD” of FIG. 14A, (b) is positioned in the “RECOMMENDED ZONE”. Thus, only (b) from among (a) to (c) satisfies the environment consideration type selection standard. That is, the server 1 selects (b) as a recommendable manufacturing process to the user from among the three patterns, which are the process patterns (a), (b) and (c).

In addition, in the case of “COST ORIENTED SELECTION STANDARD” of FIG. 14B, (b) is positioned in the “RECOMMENDED ZONE”. Thus, only (b) from among (a) to (c) satisfies the cost oriented selection standard. That is, the server 1 selects (b) as a recommendable manufacturing process to the user from among the three patterns, which are the process patterns (a), (b) and (c).

In the case of “NORMAL SELECTION STANDARD” of FIG. 14C, (a) and (b) are located in the “RECOMMENDED ZONE”. Accordingly, (a) and (b) from among (a) to (c) satisfy the normal selection standard. In this case, the server 1 computes a total values of the evaluation points of (a) and (b), and selects a larger one of the total values. Here, because (a): (5.6), the total value of the evaluation points of (a) is 11. On the other hand, the total value of the evaluation points of (b) is 18 because (b): (8.10). Thus, the server 1 selects (b) as a manufacturing process recommended to the user.

Moreover, if there is nothing located in the “RECOMMENDED ZONE”, the server 1 can select (b), as a next candidate, which is located in a middle zone between the “IMPROVEMENT ZONE” and the “RECOMMENDED ZONE”, as a manufacturing process recommended to the user. Of course, because there is nothing located in the “RECOMMENDED ZONE”, the selection itself can be disapproved.

In the present embodiment, the “EVALUATION POINT” is given to each of the computed “MANUFACTURING COST (TOTAL)” and the “CO₂ EMISSION AMOUNT”, and a determination of selection is performed based on the “EVALUATION POINT”. However, for example, the determination of selection can be made based on actual values of the “MANUFACTURING COST (TOTAL)” and the “CO₂ EMISSION AMOUNT”. In such a case, the standard values defined in the selection standard DB 2d are not the “EVALUATION POINT” but values corresponding to actual values.

Finally, in step S7, the server 1 (the output part 106) outputs the computed “MANUFACTURING COST (TOTAL)”, “CO₂ EMISSION AMOUNT”, “EVALUATION POINT”, results of selection, etc.

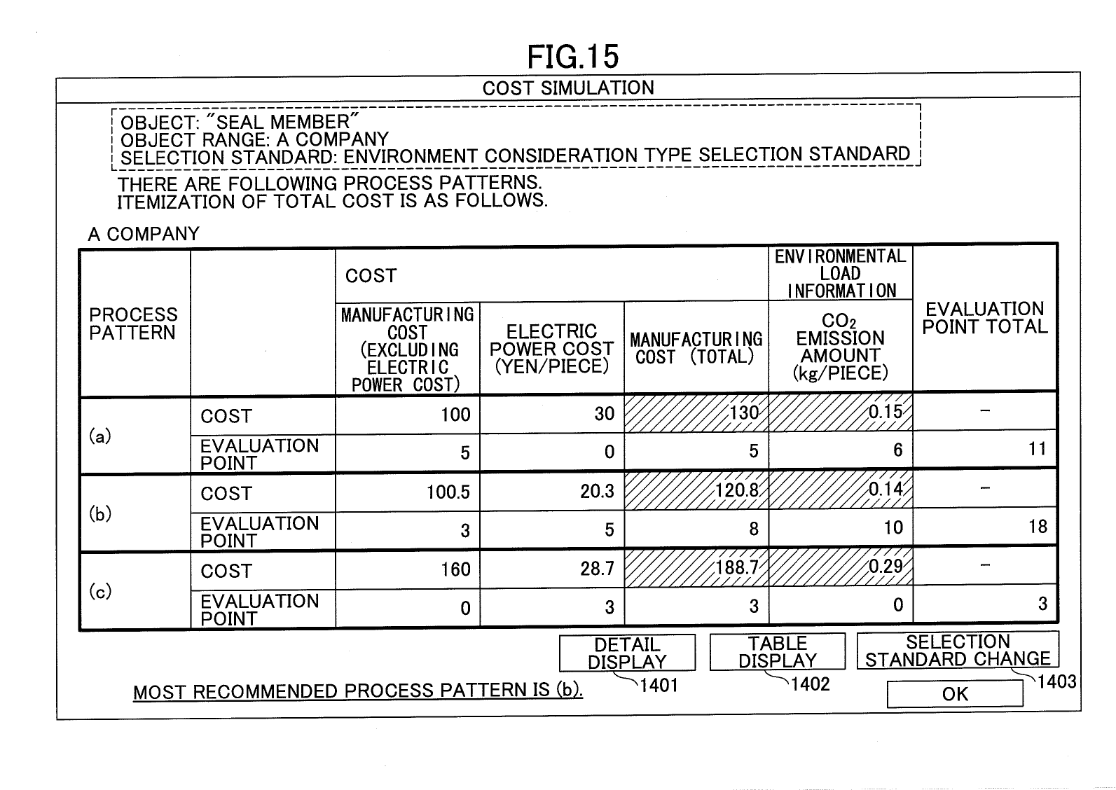

FIG. 15 illustrates a first example of a screen of the terminal 3 according to the present embodiment. A user operates the terminal 3 to input the search condition (“seal member”, “A company”, “ENVIRONMENT CONSIDERATION TYPE SELECTION STANDARD”, etc.) in order to perform a cost simulation. Thereby, as illustrated in FIG. 15, a result of computation of the “MANUFACTURING COST (TOTAL)”, the “CO₂ EMISSION AMOUNT”, and the “EVALUATION VALUE” and a result of selection are displayed for each process pattern which can manufacture the “seal member”.

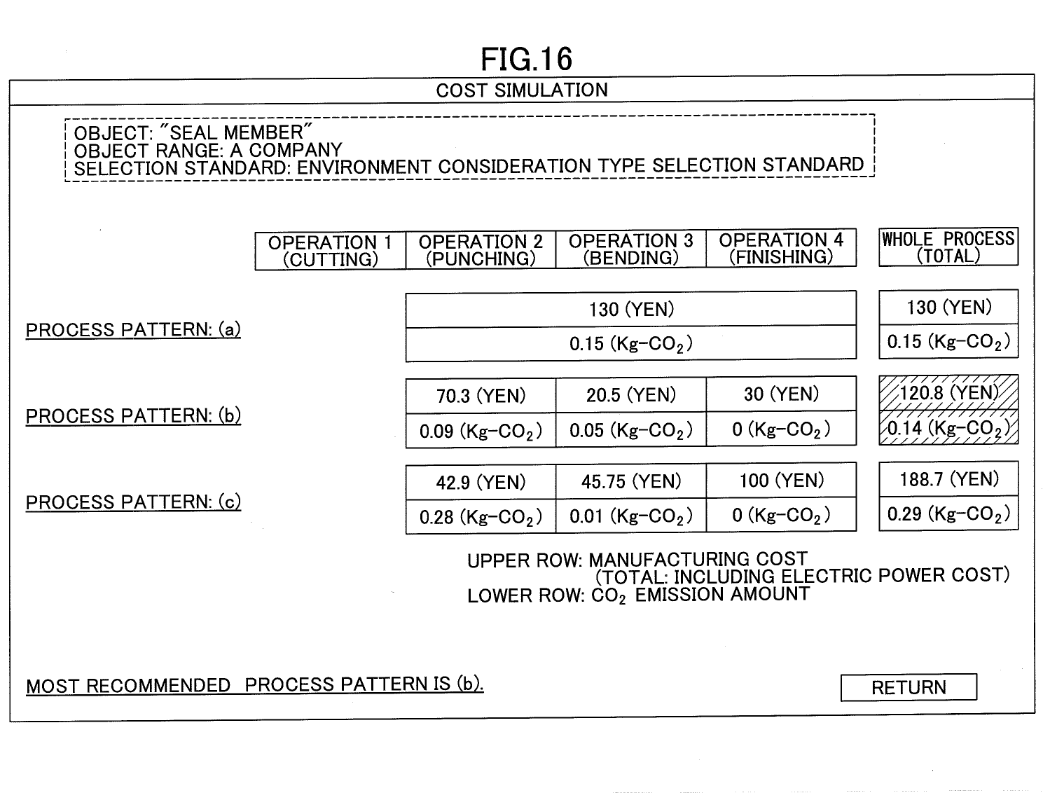

FIG. 16 illustrates a second example of the screen of the terminal 3 according to the present embodiment. For example, if “DETAIL DISPLAY” 1401 of the screen illustrated in FIG. 15 is pressed or touched, the screen display transits to the screen illustrated in FIG. 16. Here, the results of computation of the “MANUFACTURING COST (TOTAL)” and the “CO₂ EMISSION AMOUNT” are displayed for each of the processes (for example, operations 1, 2, 3, 4) of the process patterns (the “EVALUATION COST (TOTAL)” may be included). The user can grasp a degree of contribution to a cost and a degree of contribution to an environment for each operation.

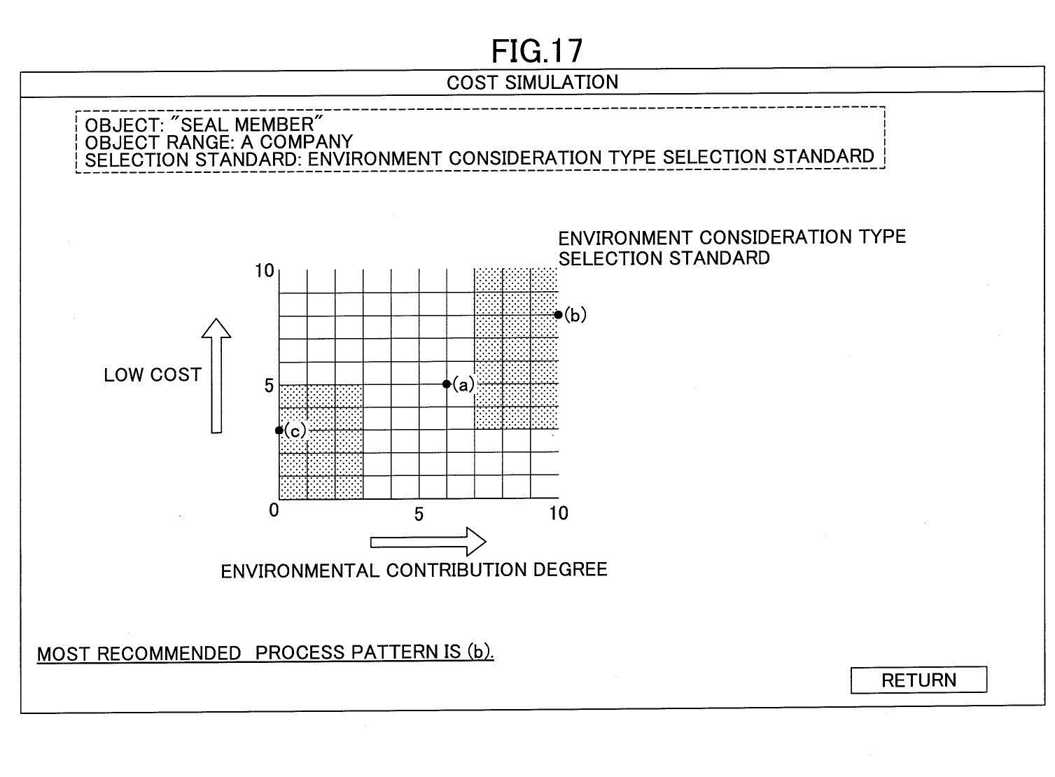

FIG. 17 illustrates a third example of the screen of the terminal 3 according to the present embodiment. For example, if “TABLE DISPLAY” 1402 illustrated in FIG. 15 is pressed or touched, the screen display transits to the screen illustrated in FIG. 17. Here, a table corresponding to the above-mentioned evaluation point plot coordinates table is displayed. Thus, the user can visually and intuitively grasp a degree of contribution to a cost and a degree of contribution to an environment for each process pattern.

Additionally, the user can change the selection standard by pressing or touching “SELECTION STANDARD CHANGE” 1403 illustrated in FIG. 15. The screen illustrated in FIG. 17 indicates a result of computation in the case of “ENVIRONMENT CONSIDERATION TYPE SELECTION STANDARD”. If the user desires to perform a simulation from a cost-oriented side, it is possible to indicate a result of computation of the case of the “COST ORIENTED TYPE SELECTION STANDARD” by selecting the “COST ORIENTED TYPE SELECTION STANDARD” (not illustrated in the figure).

As mentioned above, when the identical product (for example, a component part) can be manufactured by a plurality of process patterns, a user can use the server 1 according to the present embodiment to cause the server 1 to compute not only a cost of the product but also an environmental value (for example, CO₂ emission) simultaneously in detail. Moreover, because the evaluation point plot coordinate table is displayed on the screen, a user can select an appropriate process pattern visually and intuitively while considering a balance between a cost and an environmental value. Moreover, a user can select automatically a process pattern most suitable for a selection standard from among a plurality of selection standards.

That is, when a manufacturer manufactures a product in own plant or a supplier manufactures a product in own plant, a user can select automatically a most optimized process pattern in view of both the manufacturing cost and the environment value (for example, CO₂ emission).

Moreover, if a user sets and registers a virtual process pattern to the DB 2, the server 1 can be used as a simulator. By performing simulation repeatedly while checking and changing parameters such as equipments, a use time, a kind of electric power, etc., it is possible to manufacture a product with a lower cost and a lower environmental load.

### Second Embodiment

In the above-mentioned first embodiment, when the A company manufactures the “seal member”, a selection is made of an appropriate manufacturing process from among the three patterns, which are the process patterns (a), (b) and (c). Specifically, in the above-mentioned example, the process pattern (b) is selected in the A company to manufacture the “seal member” optimally in view of both a manufacturing process and an environment value (for example, CO₂ emission).

In the second embodiment, a manufacturer (for example, a material procurement department) uses the above-mentioned first embodiment as a material for determination when the identical “seal member” is purchased from a supplier. Specifically, an appropriate process pattern is selected for each of the A company, the B company and the C company. Upon the selection, a further appropriate process pattern is selected from among the appropriate process pattern of the A company, the B company and the C company. Thereby, the manufacturer can purchase the identical “seal member” manufactured by the appropriate process pattern from the most appropriate supplier from among the A company, the B company and the C company.

As mentioned above, it is assumed that various kinds of necessary information is stored beforehand in the DB 2 (the process operation DB 2a, the equipment DB 2b, the electric power information DB 2c, the selection standard DB 2d) by the registration part 102. In recent years, because information shearing progresses in a relationship between a manufacturer and a supplier in a parts supply system, a manufacturer commonly owns various kinds of information of a supplier such as information registered in the DB 2. In this respect, it can be understood easily if it is assumed that the manufacture and the supplier are associated companies.

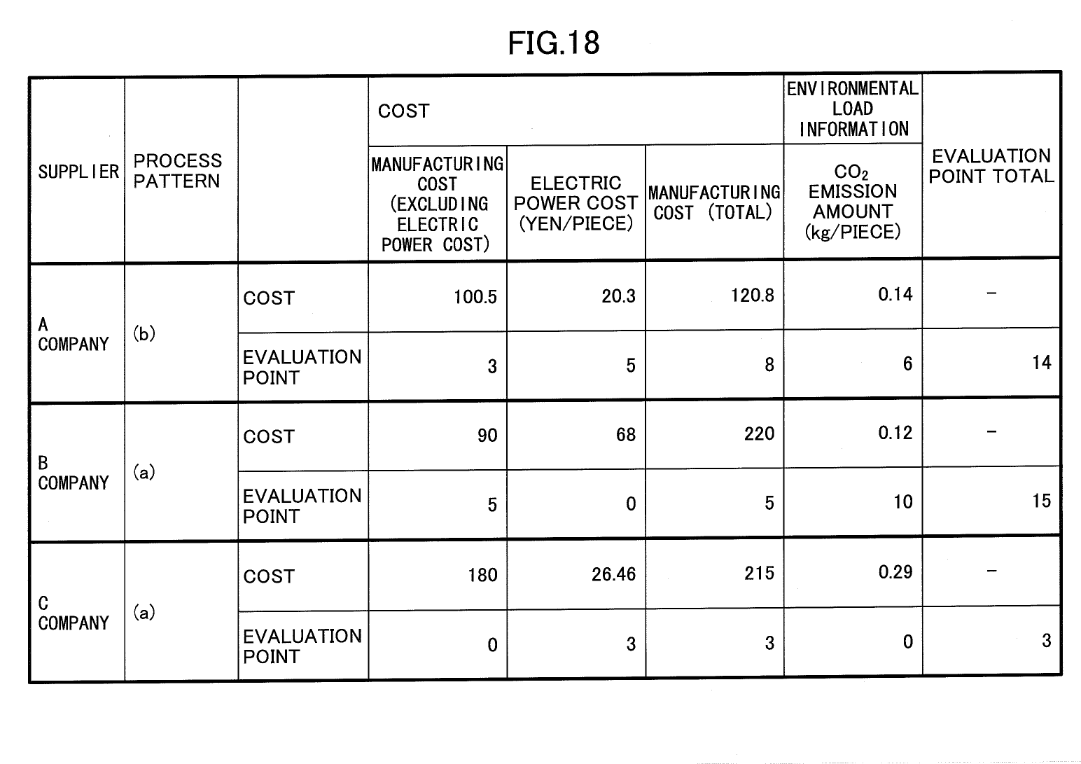

FIG. 18 is an illustration indicating a total cost and an evaluation point in each process pattern selected from the A company, the B company and the C company. In FIG. 18, “SUPPLIER”: A company and “PROCESS PATTERN”: (b) are the process pattern selected through the above-mentioned first embodiment. That is, this process pattern is selected as a most appropriate process pattern in view of both a manufacturing cost and an environment value (for example, CO₂ emission) when manufacturing (processing) the “seal member””.

On the other hand, with respect to the “SUPPLIER”: B company and C company, they are the process patterns selected through the above-mentioned first embodiment. That is, the “SUPPLIER”: B company and the “PROCESS PATTERN”: (a) is selected as the most appropriate process pattern in the B company in view of both a manufacturing cost and an environment value (for example, CO₂ emission) when manufacturing (processing) the “seal member”. Moreover, the “SUPPLIER”: C company and the “PROCESS PATTERN”: (a) is selected as the most appropriate process pattern in the C company in view of both a manufacturing cost and an environment value (for example, CO₂ emission) when manufacturing (processing) the “seal member”. The above-mentioned selections can be easily achieved according to the above-mentioned embodiment.

It should be noted that, as mentioned above, a method of giving the “EVALUATION POINT” includes (1) an evaluation method using a previously determined absolute value simply, (2) an evaluation according to a deviation, and (3) a relative evaluation according to ranking. Here, in FIG. 16, it is desirable to use (2) or (3) as a method of giving the “evaluation point”. This is because the case of (1) is not appropriate to make comparison between companies because (1) uses an absolute evaluation value based on a standard specified by each company. Accordingly, for example, in the “SUPPLIER”: A company, the “EVALUATION POINT” of the “MANUFACTURING COST (TOTAL)” is changed into 8 points (5 points in FIG. 13). This is because the “MANUFACTURING COST (TOTAL)” of the A company is given relatively in the relationship between the companies.

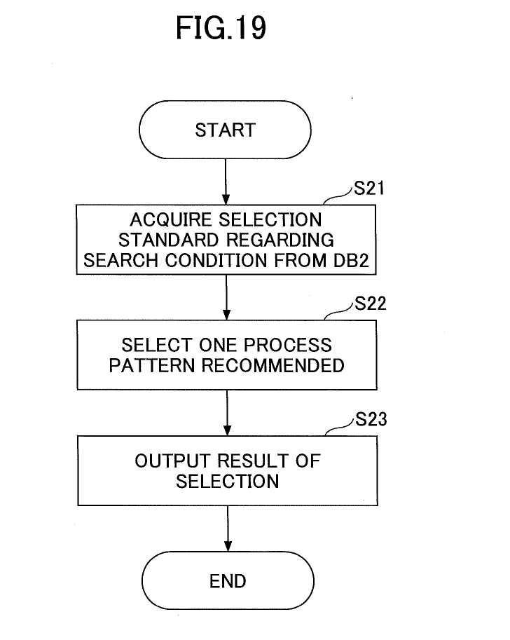

FIG. 19 is a flowchart for explaining information processing according to the second embodiment.

First, in step S21, the server 1 (the selection part 107) acquires a selection standard regarding a search condition from the DB 2. It is assumed that the input selection standard is “ENVIRONMENT CONSIDERATION TYPE SELECTION STANDARD”. Specifically, the server 1 acquires the “MANUFACTURING COST (TOTAL)” and the “CO₂ EMISSION AMOUNT” of the “IMPROVEMENT ZONE” and the “RECOMMENDED ZONE” of the “ENVIRONMENT CONSIDERATION TYPE SELECTION STANDARD” from the selection standard DB 2d using the “ENVIRONMENT CONSIDERATION TYPE SELECTION STANDARD” as a key from among the search conditions. This is to select one manufacturing process recommendable to a user from among the process patterns of each company based on the selection standard DB 2d.

Then, the server 1 (the selection part 107) selects a recommendable process pattern from among the process patterns of each company.

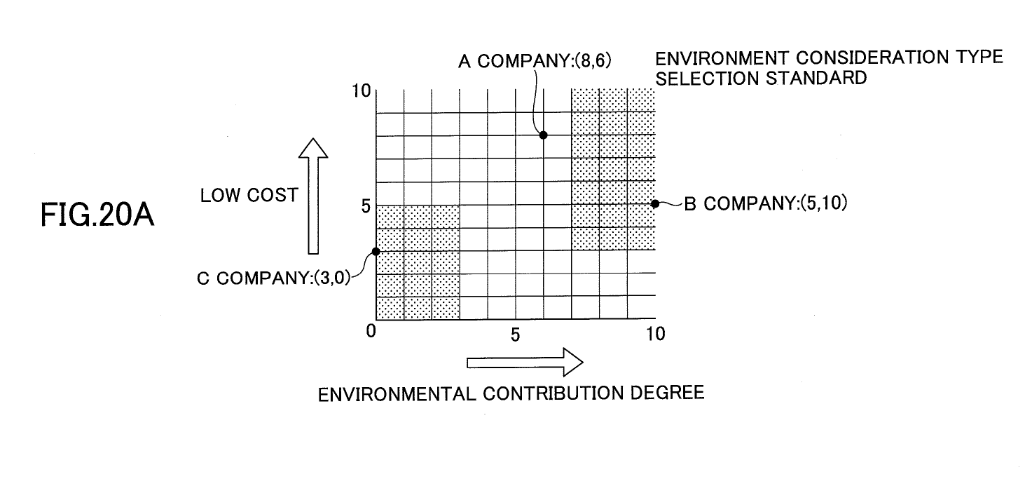

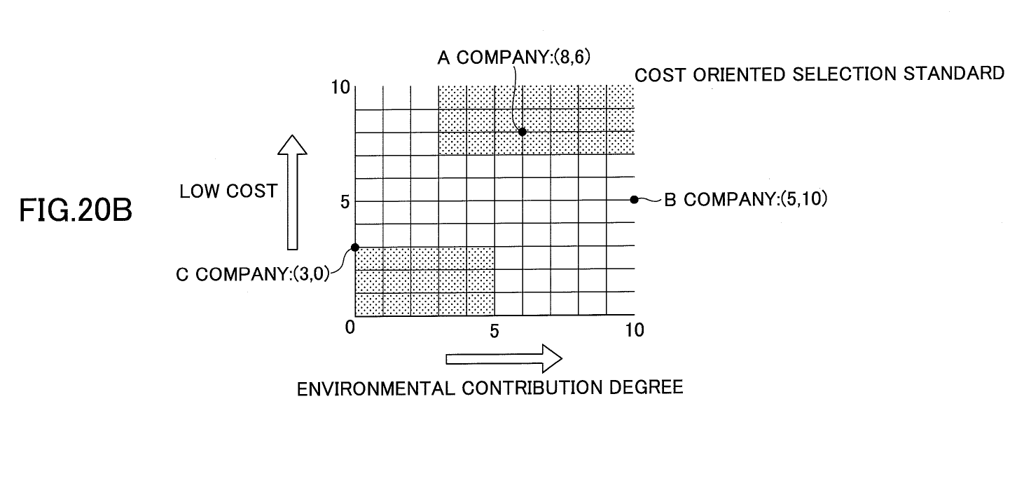

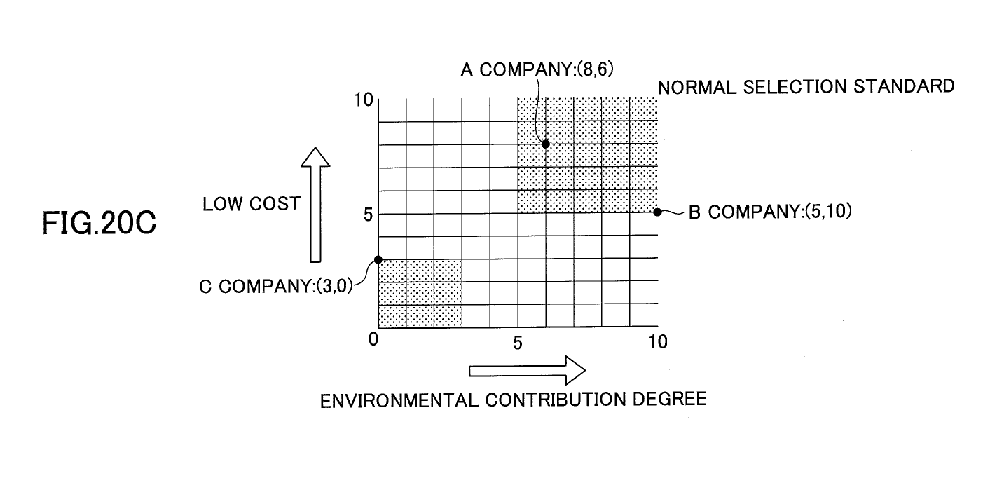

FIGS. 20A, 20B and 20C illustrate evaluation point plot coordinates tables based on the selection standard DB 2d. Referring to FIG. 20A, the “IMPROVEMENT ZONE” and the “RECOMMENDED ZONE” are indicated in the evaluation point plot coordinates table. According to the above-mentioned results of computation, the evaluation point (“MANUFACTURING COST (TOTAL)”.“CO₂ EMISSION AMOUNT”) with respect to the “MANUFACTURING COST (TOTAL)” and the “CO₂ EMISSION” for each process pattern of each company can be expressed as A company: (8.6), B company: (5.10) and C company: (3.0) (refer to FIG. 18). Accordingly, the evaluation point given to each process pattern of each company is plotted on the coordinates.

Here, in the case of the “ENVIRONMENT CONSIDERATION TYPE SELECTION STANDARD” illustrated in FIG. 20A, because the B company is located in the “RECOMMENDED ZONE”, only the B company satisfies the environment consideration type selection standard from among the A company, the B company and the C company. That is, the server 1 selects the B company: process pattern (a) as a manufacturing process recommended to the user from among the three patterns, which are the process patterns of the A company, the B company and the C company.

In addition, if the search condition indicates the “COST ORIENTED TYPE SELECTION STANDARD” as illustrated in FIG. 20B, because the A company is located in the “RECOMMENDED ZONE”, only the A company satisfies the cost oriented type selection standard from among the A company, the B company and the C company. That is, the server 1 selects the A company: process pattern (b) as a manufacturing process recommended to the user from among the three patterns, which are the process patterns of the A company, the B company and the C company.

If the search condition indicates the “NORMAL SELECTION STANDARD” as illustrated in FIG. 20C, because the A company and the B company are located in the “RECOMMENDED ZONE”, the A company and the B company satisfy the normal selection standard from among the A company, the B company and the C company. In this case, the server 1 computes the total value of the evaluation values of both the A company and the B company, and selects one of the A company and the B company having a larger total value. Accordingly, the server 1 selects the company B: process pattern (a) as a manufacturing process recommended to the user.

Finally, in step S23, the server 1 (the output part 106) outputs the results of computation including the “MANUFACTURING COST (TOTAL)”, the “CO₂ EMISSION AMOUNT”, the “EVALUATION POINT”, results of selection, etc.

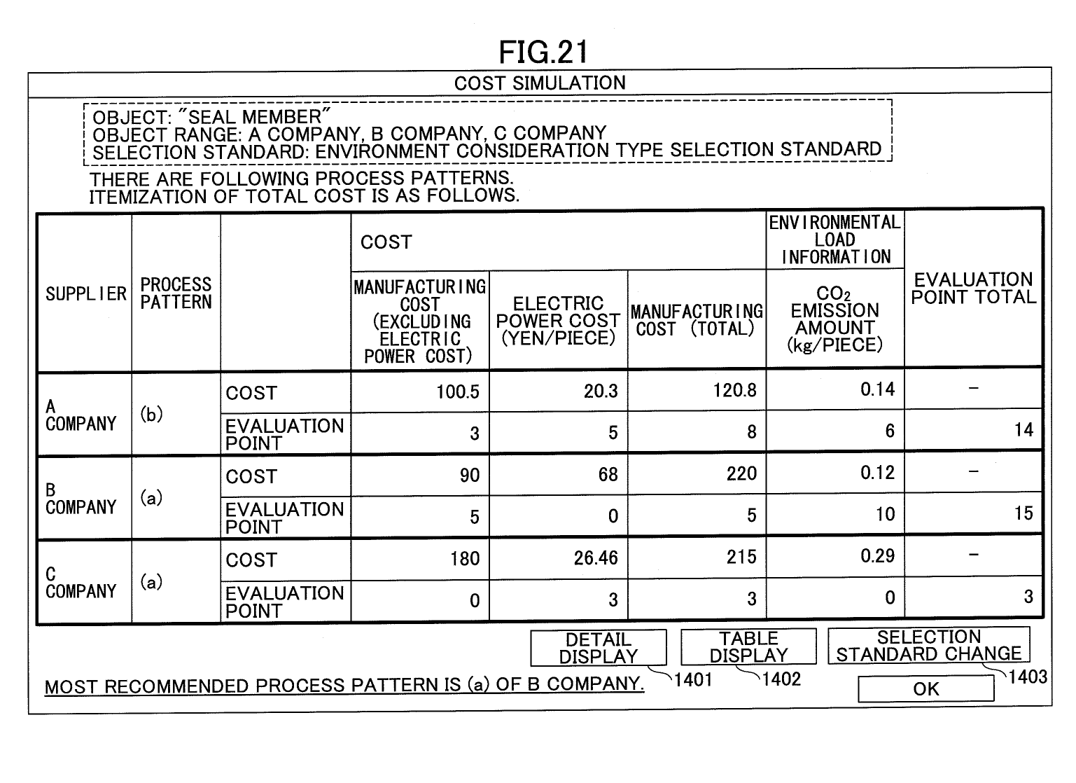

FIG. 21 illustrates a fourth example of the screen of the terminal 3 according to the present embodiment. A user operates a terminal 3 to input the search condition (the “seal member”, the “A company, B company and C company”, and the “ENVIRONMENT CONSIDERATION TYPE SELECTION STANDARD”. Then, the results of computation of the “MANUFACTURING COST (TOTAL)”, the “CO₂ EMISSION AMOUNT” and the “EVALUATION POINT” and the result of selection are displayed as illustrated in FIG. 21 for each process pattern, which is selected from each of the A company, the B company and the C company who can manufacture the “seal member”.

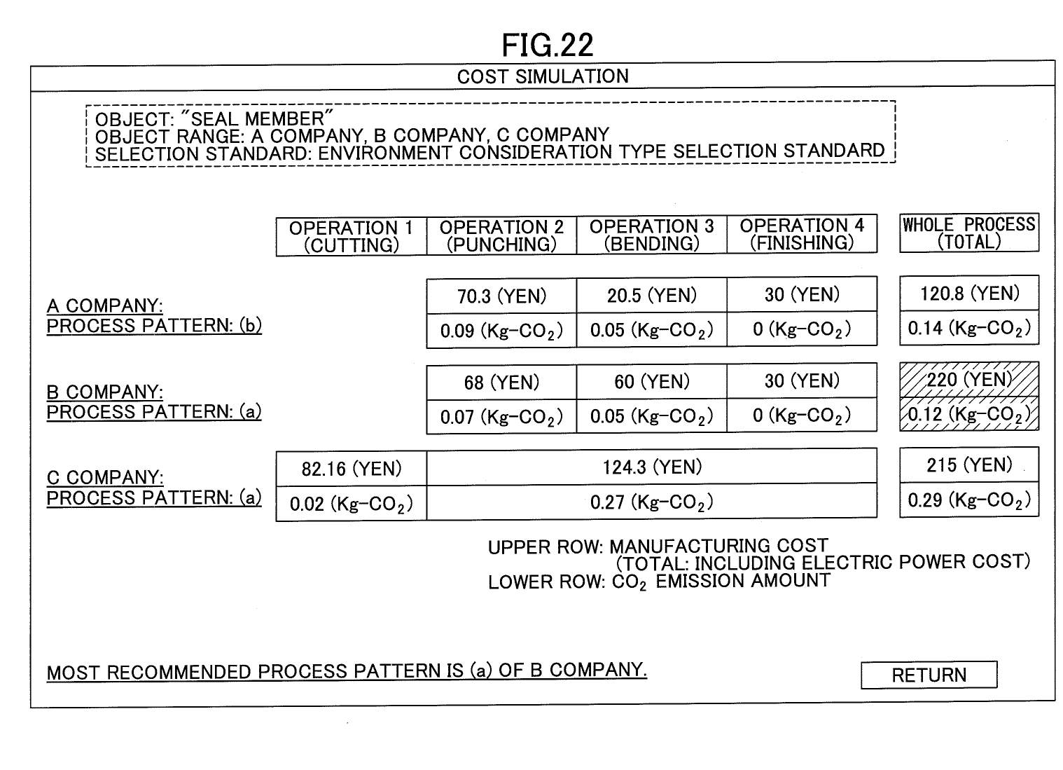

FIG. 22 illustrates a fifth example of the screen of the terminal 3 according to the present embodiment. For example, if the “DETAIL DISPLAY” 1401 illustrated in FIG. 21 is pressed or touched, the display transits to the screen illustrated in FIG. 22. Here, the results of computation of the “MANUFACTURING COST (TOTAL)” and the “CO₂ EMISSION AMOUNT” are displayed for each operation (for example, operations 1, 2, 3, 4) of the process pattern of each company (the “EVALUATION POINT” may be included). The user can grasp a degree of contribution to cost and a degree of contribution to an environment for each operation of each company in detail.

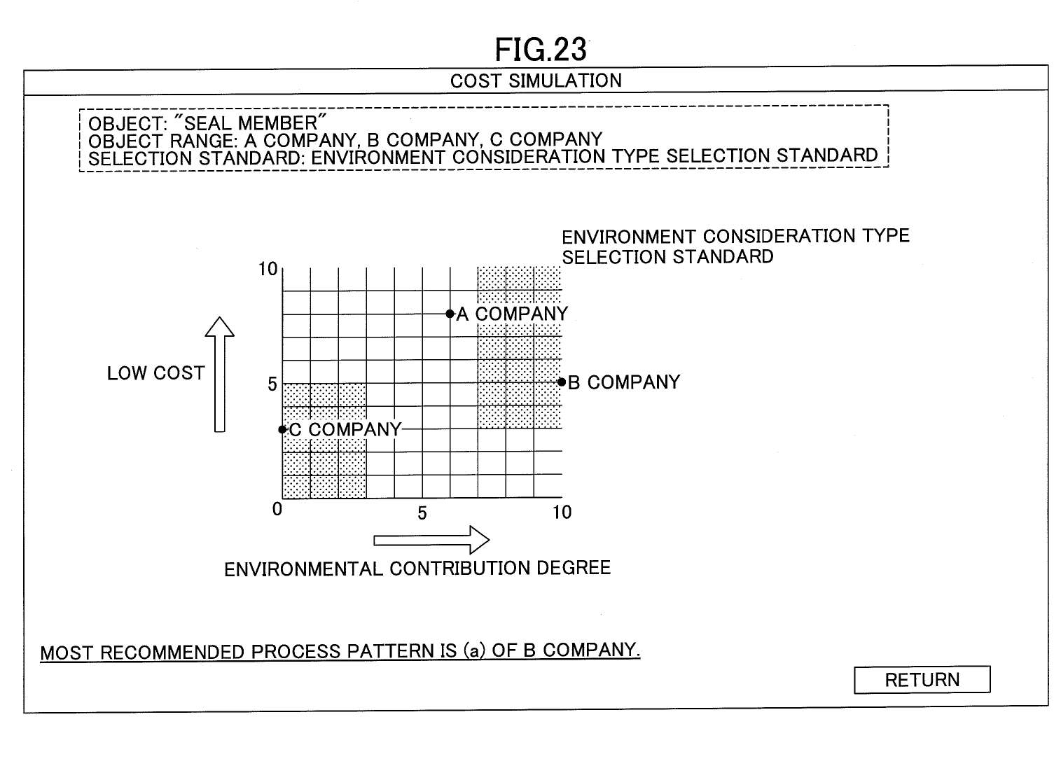

FIG. 23 illustrates a sixth example of the screen of the terminal 3 according to the present embodiment. For example, if the “TABLE DISPLAY” 1402 illustrated in FIG. 21 is pressed or touched, the display transits to the screen illustrated in FIG. 23. Here, a table corresponding to the above-mentioned evaluation point plot coordinates table is displayed. Accordingly, the user can visually and intuitively grasp a degree of contribution to cost and a degree of contribution to environment for each company.

Moreover, the user can change the selection standard by pressing or touching the “SELECTION STANDARD CHANGE” illustrated in FIG. 21. The example of the screen illustrated in FIG. 23 indicates the result of computation for the case of “ENVIRONMENT CONSIDERATION TYPE SELECTION STANDARD”. On the other hand, if the user desires to perform a simulation from a cost-oriented side, the user selects the “COST ORIENTED TYPE SELECTION STANDARD”. Thereby, the results of computation can be displayed for the case of the “COST ORIENTED TYPE SELECTION STANDARD” (not illustrated in the figure).

In addition, displayed in FIG. 21 are the optimal process pattern for each process pattern for each of the A company, the B company and the C company (that is, one for each company). However, it is also possible to finally select the optimal process pattern from among the process patterns of each company upon causing all process patterns for each company to be displayed. For example, referring to the processing operation information DB 2a (FIGS. 4A-6), the process pattern of the A company is (a), (b) and (c), the process pattern of the B company is (a) and (b), and the process pattern of the C company is (a) and (b). In this case, the total of 7 patterns of the process pattern are displayed at once, and the process pattern (b) of the B company is finally selected from among the 7 patterns.

As mentioned above, when the identical product (for example, a component part) can be manufactured by a plurality of process patterns in each of a plurality of companies, a user can use the server 1 according to the present embodiment to compute not only a cost of the product but also an environmental value (for example, CO₂ emission) simultaneously in detail for each process pattern of each company. Moreover, because the evaluation point plot coordinate table is displayed on the screen, a user can select an appropriate process pattern visually and intuitively while considering a balance between a cost and an environmental value. Moreover, a user can select automatically a process pattern most suitable for a selection standard from among a plurality of selection standards.

That is, when a manufacturer procures the identical “seal member” from a supplier, the user can automatically select the optimal one of the process patterns in view of both a manufacturing cost and an environmental value (for example, CO₂ emission amount) from among the process patterns of manufacturing the identical “seal member” of each company. That is, the user can procure the identical “seal member” from a supplier who is superior to both a viewpoint of a manufacturing cost and a viewpoint of an environmental value, or the information regarding the manufacturing process and the supplier can be used effectively as information for making a decision.

Although the embodiments have been explained with an information processing apparatus and method as an example, the present invention is not limited to the specifically disclosed embodiments, and variations and modifications may be made without departing from the scope of the present invention.

The present application is based on Japanese priority application No. 2011-278977 filed on Dec. 20, 2011, the entire contents of which are hereby incorporated herein by reference.

What is claimed is:

1. An information processing apparatus configured to output a manufacturing cost and a CO₂ emission amount for each of manufacturing processes which is capable of manufacturing an identical product, the information processing apparatus comprising:
a first storage part configured to store processing operation information in which the manufacturing processes, which can manufacture the identical product, are registered, wherein information regarding processing operations constituting each of the manufacturing processes, information regarding electric equipments used in each of the processing operations, information regarding a use time of each of the electric equipments for each of the processing operations, and a miscellaneous process cost excluding an electric power cost for each of the processing operations are also registered in the processing operation information by being associated with each other;
a second storage part configured to store equipment information in which each of the electric equipments and a power consumption per unit time of each of the electric equipments are registered in association with each other;
a third storage part configured to store electric power information in which an electric power cost per unit amount of electric power and a CO₂ emission amount per unit amount of the electric power are registered in association with each other;
a process cost computation part configured to compute a power consumption consumed in each of the processing operations based on a use time in which one of the electric equipments is used and a power consumption of the one of the electric equipments per unit time, and compute a process cost required for each of the processing operations based on the power consumption, the electric power cost per unit amount of the electric power and the miscellaneous process cost;
a processing CO₂ emission amount computation part configured to compute, for each of the manufacturing processes, a processing CO₂ emission amount exhausted in each of the processing operations based on the power consumption and the CO₂ emission amount per unit amount of the electric power;
a total cost computation part configured to compute a total cost including a process cost and a processing CO₂ emission amount required for a whole manufacturing process based on the process cost and the processing CO₂ emission amount of each of the processing operations; and
an output part configured to output the total cost for each of the manufacturing processes.

2. The information processing apparatus as claimed in claim 1, wherein:
information regarding a kind of electric power used by said electric equipments is registered in the equipment information in association with other information;
a kind of said electric power is registered in the electric power information in association with other information;
said process cost computation part computes the process cost required for each of the processing operations based on the power consumption, a kind of electric power used by the electric equipment, the electric power cost per unit amount of the electric power and the miscellaneous process cost; and
said processing CO₂ emission amount computation part computes the processing CO₂ emission amount exhausted in each processing operation based on the power consumption, a kind of the electric power used by the electric equipment and the CO₂ emission amount per unit amount of the electric power.

3. The information processing apparatus as claimed in claim 1, further comprising:
a fourth storage part configured to store selection standard information which defines, in accordance with a selection standard, the process cost and the processing CO₂ emission amount corresponding to the selection standard; and
a selection part configured to select one of the manufacturing processes, which satisfies the process cost and the processing CO₂ emission amount corresponding to the election standard, from among the plurality of the manufacturing processes based on the selection standard information,
wherein said output part outputs the selected one of the manufacturing processes.

4. The information processing apparatus as claimed in claim 3, wherein the processing operation information, the equipment information and the electric power information are stored for each company, and said selection part selects the one of the manufacturing processes for each company based on the selection standard information, and also selects one of the manufacturing processes which satisfies the process cost and the processing CO₂ emission amount corresponding to the selection standard from the plurality of the manufacturing processes selected for each company.

5. The information processing apparatus as claimed in claim 1, wherein said output part creates a coordinates table on which the process cost and the processing CO₂ emission amount corresponding to the selection standard are indicated based on the selection standard information, and displays the process cost and the processing CO₂ emission amount required for the whole manufacturing process on the coordinates table for each of the manufacturing processes.

6. The information processing apparatus as claimed in claim 1, wherein said output part outputs said total cost for each of the manufacturing processes, and also outputs the process cost and the processing CO₂ emission amount for each of the processing operations.

7. An information processing method performed by an information processing apparatus configured to output a manufacturing cost and a CO₂ emission amount for each of manufacturing processes which is capable of manufacturing an identical product, the information processing method comprising:
storing processing operation information in which the manufacturing processes, which can manufacture the identical product, are registered, wherein information regarding processing operations constituting each of the manufacturing processes, information regarding electric equipments used in each of the processing operations, information regarding a use time of each of the electric equipments for each of the processing operations, and a miscellaneous process cost excluding an electric power cost for each of the processing operations are also registered in said processing operation information by being associated with each other;
storing equipment information in which each of the electric equipments and a power consumption per unit time of each of the electric equipments are registered in association with each other;
storing electric power information in which an electric power cost per unit amount of electric power and a CO₂ emission amount per unit amount of the electric power are registered in association with each other;
computing a power consumption consumed in each of the processing operations based on a use time in which one of the electric equipments is used and a power consumption of the one of the electric equipments per unit time, and compute a process cost required for each of the processing operations based on the power consumption, the electric power cost per unit amount of the electric power and the miscellaneous process cost;
computing, for each manufacturing process, a processing CO₂ emission amount exhausted in each processing operation based on the power consumption and the CO₂ emission amount per unit amount of the electric power;
computing a total cost including a process cost and a processing CO₂ emission amount required for a whole manufacturing process based on said process cost and said processing CO₂ emission amount of each of the processing operations; and
outputting the total cost for each of the manufacturing processes.

8. A non-transitory computer readable recording medium storing a program for causing an information processing apparatus to perform an information processing method, the information processing apparatus configured to output a manufacturing cost and a CO₂ emission amount for each of manufacturing processes which is capable of manufacturing an identical product, the information processing method comprising:
storing processing operation information in which the manufacturing processes, which can manufacture the identical product, are registered, wherein information regarding processing operations constituting each of the manufacturing processes, information regarding electric equipments used in each of the processing operations, information regarding a use time of each of the electric equipments for each of the processing operations, and a miscellaneous process cost excluding an electric power cost for each of the processing operations are also registered in said processing operation information by being associated with each other;
storing equipment information in which each of the electric equipments and a power consumption per unit time of each of the electric equipments are registered in association with each other;
storing electric power information in which an electric power cost per unit amount of electric power and a CO₂ emission amount per unit amount of the electric power are registered in association with each other;
computing a power consumption consumed in each of the processing operations based on a use time in which one of the electric equipments is used and a power consumption of the one of the electric equipments per unit time, and compute a process cost required for each of the processing operations based on the power consumption, the electric power cost per unit amount of the electric power and the miscellaneous process cost;
computing, for each of the manufacturing processes, a processing CO₂ emission amount exhausted in each processing operation based on the power consumption and the CO₂ emission amount per unit amount of the electric power;
computing a total cost including a process cost and a processing CO₂ emission amount required for a whole manufacturing process based on said process cost and said processing CO₂ emission amount of each of the processing operations; and
outputting the total cost for each of the manufacturing processes.
